(19) United States
(12) Patent Application Publication
(10) Pub. No.: US 2026/0134215 A1
(43) Pub. Date: May 14, 2026

(54) AUGMENTING FUNCTIONALITY OF GENERATIVE LANGUAGE MODELS USING A HYBRID ATTENTION METHOD

(71) Applicant: Adobe Inc., San Jose, CA (US)

(72) Inventors: Savya Khosla, Champaign, IL (US); Simon Jenni, Hägendorf (CH); Kushal Kafle, Boston, MA (US); John Collomosse, Woking (GB); Jing Shi, Rochester, NY (US); Handong Zhao, San Jose, CA (US)

(21) Appl. No.: 18/946,080

(22) Filed: Nov. 13, 2024

(51) Int. Cl. G06F 40/284

(52) U.S. Cl. CPC G06F 40/284

(57) ABSTRACT

The present disclosure relates to systems, non-transitory computer-readable media, and methods for augmenting the functionality of large language models using a hybrid causal-bidirectional attention method. In particular, the disclosed systems generate, from a plurality of tokens interpretable by a large language model, a set of context tokens comprising tokens with bidirectional attention and a set of span tokens comprising tokens with causal attention and bidirectional attention. Additionally, the disclosed systems modify parameters of the large language model at a first training stage by utilizing a first loss function that incorporates the set of context tokens and a second loss function that incorporates the set of span tokens. Further, the disclosed systems modify the parameters of the large language model at a second training stage by utilizing the first loss function, the second loss function, and a third loss function that incorporates the set of context tokens.

### BACKGROUND

Language models have transformed natural language processing, powering applications for text annotation, machine translation, summarization, and speech recognition. Language models often fall into one of three main categories: 1) encoder-only models which focus on encoding input into fixed-dimensional representations for tasks such as sentiment analysis, 2) decoder-only models which are adept at generating coherent text for tasks like creative content generation and dialogue systems, and 3) encoder-decoder models which implement an encoder to understand input and a decoder to generate output, rendering this architecture suitable for tasks like machine translation and summarization. Despite their advancements, existing systems have inherent limitations and challenges that affect their performance across different tasks. For instance, while certain existing model architectures are effective at generative token prediction, conventional training approaches render them unsuitable for tasks such as text infilling and missing span generation. Conversely, methods that enhance large language models for text infilling render them unsuitable for text encoding.

### SUMMARY

Embodiments of the present disclosure provide benefits and/or solve one or more of the foregoing or other problems in the art with systems, non-transitory computer-readable media, and methods for augmenting the functionality of a large language model using a hybrid causal-bidirectional attention method. In particular, the disclosed systems provide an adaptation of decoder-only large language models for: 1) generating robust sentence-level and token-level representations, 2) infilling missing spans while preserving coherence with bidirectional context, and 3) performing open-ended text generation. To generate a decoder-only model capable of such tasks, the disclosed systems utilize a specialized training approach that involves generating a set of context tokens with bidirectional attention and a set of span tokens with both causal attention and bidirectional attention. Further, in some embodiments, the disclosed systems modify the parameters of a large language model by utilizing loss functions that incorporate the context tokens and/or the span tokens. Moreover, in some implementations, the disclosed systems modify the parameters of a (decoder-only) large language model using varying combinations of the loss functions at different training stages. Indeed, by modifying the parameters of the large language model in this manner, the disclosed systems augment the functionality of the large language model to enable masked next token prediction, missing span generation, and self-supervised contrastive learning.

Additional features and advantages of one or more embodiments of the present disclosure are outlined in the description which follows, and in part are determined from the description, or are learned by the practice of such example embodiments.

### BRIEF DESCRIPTION OF THE DRAWINGS

The detailed description provides one or more embodiments with additional specificity and detail through the use of the accompanying drawings, as briefly described below.

FIG. 1 illustrates an example system environment in which a bidirectional decoder training system operates in accordance with one or more embodiments.

FIG. 2 illustrates an overview diagram of the bidirectional decoder training system augmenting the functionality of a large language model based on a set of context tokens and a set of span tokens in accordance with one or more embodiments.

FIG. 3 illustrates a diagram of the bidirectional decoder training system generating context tokens and span tokens using a hybrid attention mask in accordance with one or more embodiments.

FIG. 4 illustrates a diagram of the bidirectional decoder training system training a large language model for masked next token prediction in accordance with one or more embodiments.

FIG. 5 illustrates a diagram of the bidirectional decoder training system training a large language model for self-supervised contrastive learning in accordance with one or more embodiments.

FIG. 6 illustrates a diagram of the bidirectional decoder training system training a large language model for missing span generation in accordance with one or more embodiments.

FIG. 7 illustrates a diagram of the bidirectional decoder training system training the large language model for additional functions at multiple training stages in accordance with one or more embodiments.

FIG. 8 illustrates a diagram of the bidirectional decoder training system jointly training the large language model according to multiple training objectives in accordance with one or more embodiments.

FIG. 9 illustrates a diagram of the bidirectional decoder training system using a decoder-only large language model to generate a token embedding, an infill text, and/or predicted text in accordance with one or more embodiments.

FIGS. 10A-10G illustrate augmented functionality results achieved by a decoder-only large language model trained using the bidirectional decoder training system compared with example functionality results of conventional models in accordance with one or more embodiments.

FIG. 11 illustrates an example schematic diagram of the sys in accordance with one or more embodiments.

FIG. 12 illustrates an example series of acts for modifying parameters of a large language model using loss functions at separate training stages in accordance with one or more embodiments.

FIG. 13 illustrates an example series of acts for modifying parameters of a large language model using a series of loss functions incorporating context tokens and span tokens in accordance with one or more embodiments.

FIG. 14 illustrates an example series of acts for generating a token embedding or an infill text using a decoder-only large language model in accordance with one or more embodiments.

FIG. 15 illustrates a block diagram of an example computing device for implementing one or more embodiments of the present disclosure.

### DETAILED DESCRIPTION

This disclosure describes one or more embodiments of a bidirectional decoder training system that augments the functionality of a large language model using a hybrid causal-bidirectional attention method. Specifically, the bidirectional decoder training system generates a set of context tokens that capture bidirectional attention and a set of span tokens that capture both causal attention and bidirectional attention. Furthermore, in one or more embodiments, the bidirectional decoder training system modifies the parameters of a (decoder-only) large language model using loss functions that incorporate the context tokens and/or the span tokens. Additionally, in one or more implementations, the bidirectional decoder training system modifies the parameters of the large language model using varying combinations of the loss functions at multiple training stages, one using one set of loss functions and other using another set of loss functions. By modifying the parameters of the large language model in this manner, the bidirectional decoder training system augments the functionality of the large language model by enabling or retaining masked next token prediction, missing span generation, and self-supervised contrastive learning, even for a large language model having a decoder-only architecture.

As mentioned above, in some embodiments, the bidirectional decoder training system generates a set of context tokens with bidirectional attention and a set of span tokens with causal attention and bidirectional attention. Specifically, the bidirectional decoder training system uses a specialized mask to generate the set of context tokens and the set of span tokens. For example, in some implementations, the bidirectional decoder training system masks input tokens interpretable by a large language model using a causal-bidirectional hybrid attention mask. In particular, the bidirectional decoder training system uses the causal-bidirectional hybrid attention mask to assign some of the input tokens as context tokens having bidirectional attention with one another. Further, in one or more embodiments, the bidirectional decoder training system uses the causal-bidirectional hybrid attention mask to assign some of the input tokens as span tokens having causal attention with one another and bidirectional attention with the set of context tokens.

As noted above, in one or more implementations, the bidirectional decoder training system modifies the parameters of a large language model using various loss functions that incorporate the context tokens and/or the span tokens. In particular, the bidirectional decoder training system uses a masked next token prediction loss function that incorporates the set of context tokens to modify the parameters of the large language model. Moreover, in some embodiments, the bidirectional decoder training system uses a self-supervised contrastive learning loss function that also incorporates the set of context tokens to modify the parameters of the large language model. Furthermore, in some implementations, the bidirectional decoder training system uses a missing span generation loss function that incorporates the span tokens and the context tokens to modify the parameters of the large language model.

As mentioned previously, in one or more embodiments, the bidirectional decoder training system modifies the parameters of the large language model using varying combinations of the loss functions at different training stages. Specifically, the bidirectional decoder training system uses masked next token prediction loss function and the missing span generation loss function in a first training stage. Additionally, in one or more implementations, the bidirectional decoder training system uses the self-supervised contrastive learning loss function in addition to the masked next token prediction loss function and the missing span generation loss function in a second training stage. In some cases, the bidirectional decoder training system applies the training stages by generating predictions and modifying model parameters using respective loss functions based on the predictions. For instance, the bidirectional decoder training system performs uses the loss functions at each of a number of overall training iterations, where a first training stage includes a first number of iterations and a second training stage includes a second number of iterations continuing from the first training stage.

As noted previously, in some embodiments, by modifying the parameters of the large language model using the loss functions incorporating the context tokens and the span tokens, the bidirectional decoder training system augments the functionality of the large language model. For example, by using the masked next token prediction loss function, the bidirectional decoder training system enables masked next token prediction (and bidirectional attention) in the large language model (e.g., a decoder-only large language model). Further, in some implementations, by using the missing span generation loss function, the bidirectional decoder training system enables missing span generation in the large language model while retaining (e.g., in a decoder-only large language model) the capability to generate predicted text (e.g., from left-to-right). Moreover, in one or more embodiments, by using the self-supervised contrastive learning loss function, the bidirectional decoder training system enables self-supervised contrastive learning in the large language model.

Additionally, in some implementations, the bidirectional decoder training system uses the large language model to generate outputs such as a token embedding, an infill request, and/or predicted text. Specifically, the bidirectional decoder training system does so using a decoder-only large language model with the additional functions enabled (i.e., masked next token prediction, self-supervised contrastive learning, and missing span generation). For example, the bidirectional decoder training system receives a prompt, extracts tokens from the prompt, and generates the outputs using the decoder-only large language model trained based on the loss functions and/or training stages described herein.

As suggested above, conventional systems exhibit a variety of disadvantages or deficiencies. For example, some existing systems suffer from inflexibility and inaccuracy. Relating to their inflexibilities, conventional systems are rigidly limited to architecture-specific functions or tasks, where conventional training of existing architectures enables some functions at the expense of others. For instance, existing systems that utilize decoder-only architectures for large language models often use training approaches that enable the models to generate text from left to right, but these training approaches of decoder-only architectures prevent or inhibit adaptation to other tasks, such as representation learning or missing span generation. Similarly, conventional systems with encoder architectures or encoder-decoder architectures likewise prevent model adaptation to tasks traditionally left to decoder models, such as creative text generation or dialogue systems.

In addition to their operational inflexibility, some conventional systems inaccurately perform functions that require bidirectional attention and/or that require capturing the context of an input. For instance, due to the limitations of existing training approaches, using decoder-only large language models for tasks other than those traditionally ascribed to decoders (e.g., creative content generation and dialogue systems) results in inaccurate and unreliable output. Additionally, while some prior systems have attempted to adapt decoder models for functionalities such as text infilling or token encoding, these systems nevertheless perform inaccurately. Indeed, the training approaches of such systems cannot capture bidirectionality and thus result in models that inaccurately generate text infilling or generate token embeddings that lack robustness.

As suggested by the foregoing, embodiments of the bidirectional decoder training system provide a variety of improvements relative to conventional systems. For example, by augmenting the functionalities of large language models—and particularly decoder-based or decoder-only large language models—the bidirectional decoder training system improves flexibility relative to conventional systems. Specifically, the bidirectional decoder training system trains large language models, such as a decoder-only large language model, to perform functions that require both causal attention and bidirectional attention (something not found in prior decoder large language models). For example, using specialized loss functions that incorporate span tokens and context tokens, the bidirectional decoder training system trains a decoder-only large language model to perform tasks such as representation learning and text infilling (tasks ordinarily not found in decoder models and only found in encoder models or encoder-decoder models), while maintaining the traditional decoder functionality of generating text (i.e., from left to right).

Indeed, in one or more implementations, the bidirectional decoder training system trains a decoder-only large language model to perform these additional functions by training the model to capture bidirectionality. For instance, the bidirectional decoder training system uses a causal-bidirectional hybrid attention mask to generate context tokens that capture or encode bidirectional attention and span tokens that capture or encode both causal attention and bidirectional attention. Furthermore, in these or other embodiments, the bidirectional decoder training system utilizes loss functions that incorporate the context tokens and span tokens to modify the parameters of the large language model thereby enabling masked next token prediction, missing span generation, and self-supervised contrastive learning. Thus, the bidirectional decoder training system improves the flexibility of decoder-only large language models by expanding their capabilities beyond text generation to other tasks not found in conventional systems, such as representation learning and text infilling.

Additionally, by training large language models using tokens with bidirectional attention and/or causal attention, embodiments of the bidirectional decoder training system improve accuracy relative to conventional systems. Specifically, the bidirectional decoder training system not only augments and expands the range of the functionalities of a large language model, but also improves the accuracy of a decoder-only large language model. For example, relative to conventional systems which exhibit poor performance in tasks outside of next token content generation, the bidirectional decoder training system trains decoder-only large language models to more accurately perform missing span generation and representation learning (e.g., token encoding). Indeed, the bidirectional decoder training system does so by using a causal-bidirectional hybrid attention mask to generate context tokens and span tokens for loss functions that incorporate the context tokens and span tokens as described herein.

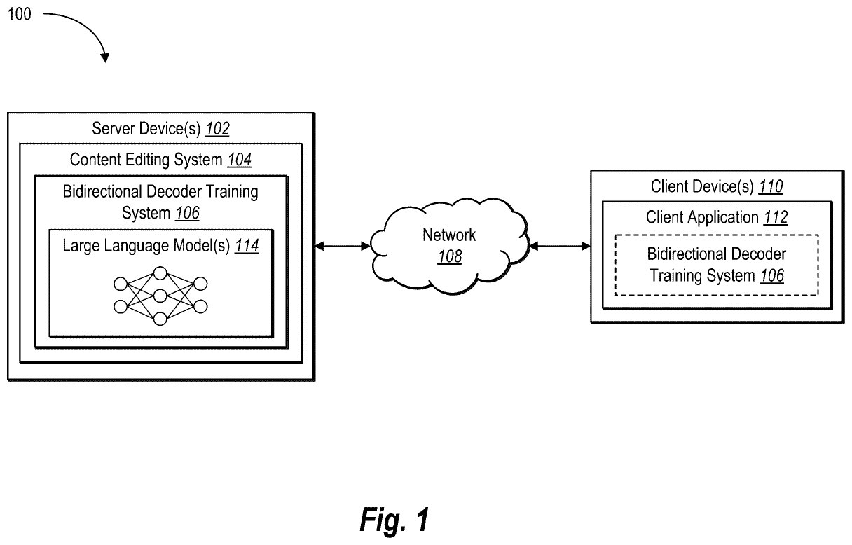

Additional detail regarding the bidirectional decoder training system 106 will now be provided with reference to the figures. For example, FIG. 1 illustrates a schematic diagram of a system environment 100 in which a bidirectional decoder training system 106 operates. As illustrated in FIG. 1, the system environment 100 includes a server device(s) 102, a network 108, and a client device(s) 110. Although the system environment 100 of FIG. 1 is depicted as having a particular number of components, the system environment 100 is capable of having any number of additional or alternative components (e.g., any number of server devices, client devices, or other components in communication with the bidirectional decoder training system 106 via the network 108). Similarly, although FIG. 1 illustrates a particular arrangement of the server device(s) 102, the network 108, and the client device(s) 110, various additional arrangements are possible.

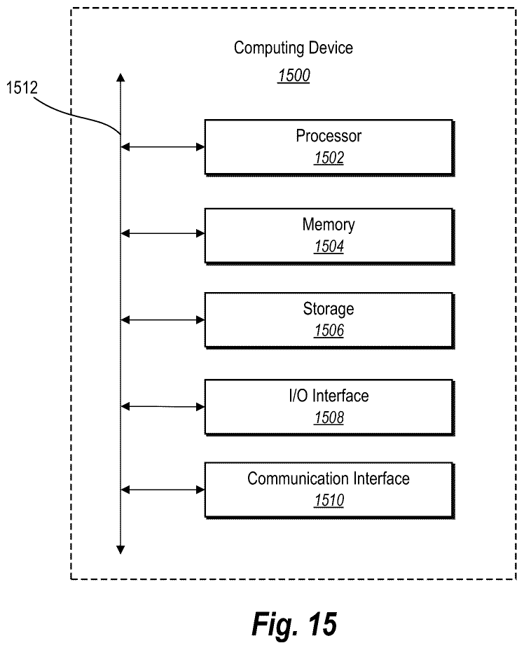

The server device(s) 102, the network 108, and the client device(s) 110 are communicatively coupled with each other either directly or indirectly (e.g., through the network 108 discussed in greater detail below in relation to FIG. 15). Moreover, the server device(s) 102 and the client device(s) 110 include one or more of a variety of computing devices (including one or more computing devices as discussed in greater detail with relation to FIG. 15).

As mentioned above, the system environment 100 includes the server device(s) 102. In one or more embodiments, the server device(s) 102 generates, stores, receives, and/or transmits data including notifications, models, and digital images. In one or more embodiments, the server device(s) 102 comprises a data server. In some implementations, the server device(s) 102 comprises a communication server, a content editing server, or a web-hosting server.

As shown, the server device(s) 102 includes a content editing system 104. In one or more embodiments, the content editing system 104 provides functionality by which a client device (e.g., the client device(s) 110) views, generates, stores, and/or edits digital documents including artificial intelligence content. For example, in some instances, a client device sends a digital document to the content editing system 104 hosted on the server device(s) 102 via the network 108. The content editing system 104 then provides options usable by the client device to edit the digital documents, store the digital documents, and subsequently search for, access, and view the digital documents. To illustrate, the content editing system 104 provides one or more options that are usable by the client device to train one or more large language models and/or generate content therefrom.

As further shown, the server device(s) 102 also include the bidirectional decoder training system 106 training large language models (e.g., the large language model(s) 114) and/or generating content such as text therefrom in the content editing system 104. In one or more embodiments, the bidirectional decoder training system 106 generates context tokens and span tokens based on training data using a hybrid attention mask (e.g., a causal-bidirectional hybrid attention mask). In particular, as will be explained below, the bidirectional decoder training system 106 uses the context tokens and span tokens with one of more loss functions to modify parameters of a large language model to enable additional large language model functions. For example, the bidirectional decoder training system 106 enables masked next token prediction, missing span generation, and/or self-supervised contrastive learning. Further, the bidirectional decoder training system 106 access the large language model with parameters modified as just described to generate outputs such as text infills, token embeddings, and/or left-to-right generated text.

As illustrated in FIG. 1, the bidirectional decoder training system 106 includes a large language model(s) 114. Indeed, in these or other embodiments, the bidirectional decoder training system 106 accesses the large language model(s) 114 to modify parameters thereof or implements the large language model(s) 114 to generate and/or implement generated outputs such as generated text or embeddings. In some cases, the large language model(s) 114 are external to the bidirectional decoder training system 106, but the bidirectional decoder training system 106 nevertheless accesses and utilizes the large language model(s) 114 via one or more plugins, APIs, or other network-based access protocols.

In some embodiments, a large language model includes or refers to a specialized type of machine learning model, and more particularly, a specialized type of neural network. For example, a machine learning model includes a computer algorithm or a collection of computer algorithms that automatically improve for a particular task through iterative outputs or predictions based on use of data. To illustrate, a machine learning model utilizes one or more learning techniques to improve in accuracy and/or effectiveness. Example machine learning models include various types of neural networks, decision trees, support vector machines, linear regression models, and Bayesian networks.

Along these lines, a neural network refers to a machine learning model that is trained and/or tuned based on inputs to generate digital content such as text and images, and to determine classifications, scores, or approximate unknown functions. For example, a neural network includes a model of interconnected artificial neurons (e.g., organized in layers) that communicate and learn to approximate complex functions and generate outputs (e.g., information flow patterns) based on a plurality of inputs provided to the neural network. In some cases, a neural network refers to an algorithm (or set of algorithms) that implements deep learning techniques to model high-level abstractions in data. In some embodiments, a neural network includes various layers such as an input layer, one or more hidden layers, and an output layer that each perform tasks for processing data. For example, a neural network includes a deep neural network, a convolutional neural network, a recurrent neural network (e.g., an LSTM), a graph neural network, a transformer neural network, a diffusion neural network, a multi-scale attention network, or a large language model.

In one or more implementations, the large language model(s) 114 includes an artificial intelligence model capable of processing and generating natural language text or other language-based prompts using language understanding. In particular, large language models are trained on large amounts of data to learn patterns and rules of language. As such, a large language model post-training is capable of generating output predictions such as predicted text (e.g., left-to-right predicted text). Further, in some embodiments, a large language model includes or refers to one or more decoder-only large language models capable of processing language-based prompts (e.g., natural language text) to generate outputs such as predicted text. In particular, a large language model includes parameters trained (e.g., via deep learning) on large amounts of data to learn patterns and rules of language for summarizing and/or generating text.

In one or more embodiments, the client device(s) 110 includes a computing device that accesses, edits, segments, modifies, stores, and/or provides, for display, digital content such as digital documents with artificial intelligence generated content. For example, in some embodiments, the client device(s) 110 includes a smartphone, a tablet, a desktop computer, a laptop computer, a head-mounted-display device, or another electronic device, including those explained below with reference to FIG. 15. In some instances, the client device(s) 110 includes one or more applications (e.g., a client application 112) that access, edit, segment, modify, store, and/or provide, for display, digital content such as digital documents with artificial intelligence generated content. For example, in one or more embodiments, the client application 112 includes a software application installed on the client device(s) 110. Additionally, or alternatively, the client application 112 includes a web browser or other application that accesses a software application hosted on the server device(s) 102 (and supported by the content editing system 104).

Additionally, as shown in FIG. 1, the system environment 100 includes the network 108. The network 108 enables communication between components of the system environment 100. In one or more embodiments, the network 108 may include the Internet or World Wide Web. Additionally, the network 108 optionally include various types of networks that use various communication technology and protocols, such as a corporate intranet, a virtual private network (VPN), a local area network (LAN), a wireless local network (WLAN), a cellular network, a wide area network (WAN), a metropolitan area network (MAN), or a combination of two or more such networks. Indeed, the server device(s) 102 and the client device(s) 110 communicates via the network using one or more communication platforms and technologies suitable for transporting data and/or communication signals, including any known communication technologies, devices, media, and protocols supportive of data communications, examples of which are described with reference to FIG. 15.

To provide an example implementation, in some embodiments, the bidirectional decoder training system 106 on the server device(s) 102 supports the bidirectional decoder training system 106 on the client device(s) 110. For instance, in some cases, the bidirectional decoder training system 106 on the server device(s) 102 generates or learns parameters for the large language model(s) 114. The bidirectional decoder training system 106 then, via the server device(s) 102, provides the large language model(s) 114 to the client device(s) 110. In other words, the client device(s) 110 obtains (e.g., downloads) the large language model(s) 114 from the server device(s) 102. Once downloaded, the bidirectional decoder training system 106 on the client device(s) 110 uses the large language model(s) 114 to train and or implement the large language models to generate and implement outputs such as text and/or token embeddings independent of the server device(s) 102. In some implementations, the bidirectional decoder training system 106 generates or learns parameters for the large language model(s) 114 on the client device(s) 110.

In alternative implementations, the bidirectional decoder training system 106 includes a web hosting application that allows the client device(s) 110 to interact with content and services hosted on the server device(s) 102. To illustrate, in one or more implementations, the client device(s) 110 accesses a software application supported by the server device(s) 102. The client device(s) 110 provides input to the server device(s) 102, such as a training data and/or digital documents for use as input and/or for incorporation with the output of large language model. In response, the bidirectional decoder training system 106 on the server device(s) 102 generates modified parameters of a large language model or generated text (e.g., infill text) and/or token embeddings using the large language model with the modified parameters. The server device(s) 102 then provides the generated text and/or the token embeddings to the client device(s) 110 for display and/or further processing.

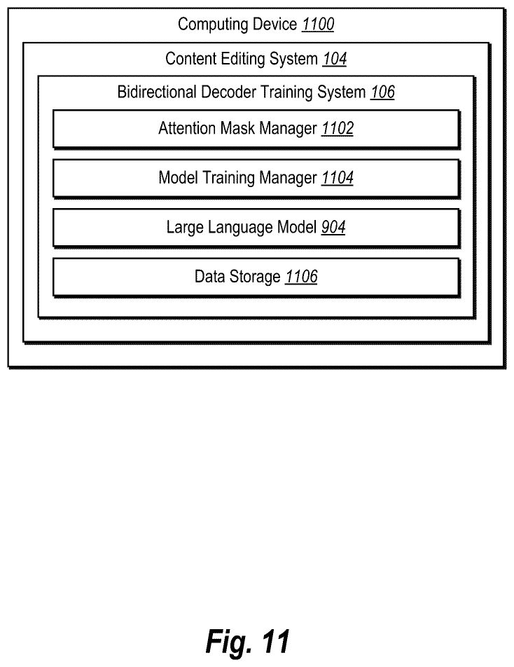

Although FIG. 1 illustrates the bidirectional decoder training system 106 implemented with regard to the server device(s) 102, different components of the bidirectional decoder training system 106 are able to be implemented by a variety of devices within the system environment 100. For example, in some instances, a different computing device (e.g., the client device(s) 110) or a separate server from the server device(s) 102 implements one or more (or all) components of the bidirectional decoder training system 106. Indeed, as shown in FIG. 1, the client device(s) 110 includes the bidirectional decoder training system 106. Example components of the bidirectional decoder training system 106 will be described below with regard to FIG. 11.

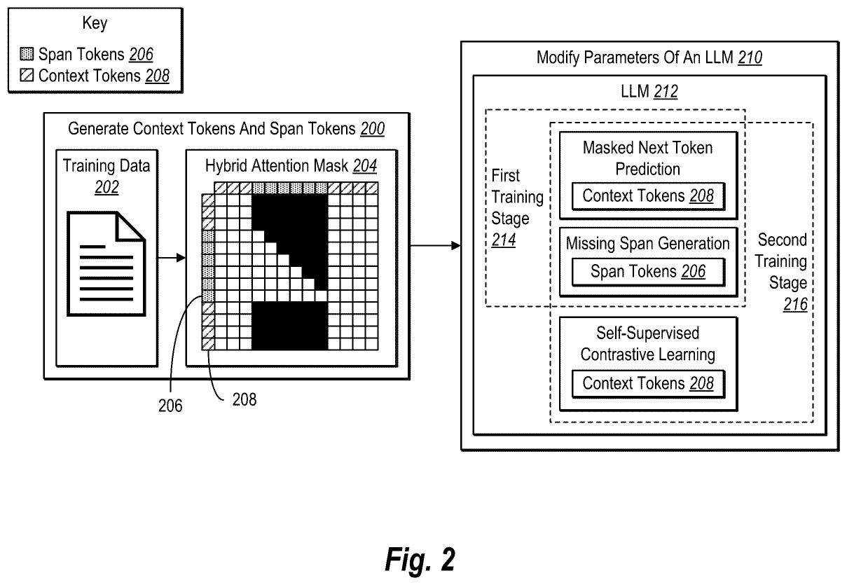

As previously mentioned, in some embodiments, the bidirectional decoder training system 106 augments the functionality of a large language model using a hybrid causal-bidirectional attention method. FIG. 2 illustrates an overview diagram of the bidirectional decoder training system 106 augmenting the functionality of a large language model using a hybrid causal-bidirectional attention method in accordance with one or more embodiments.

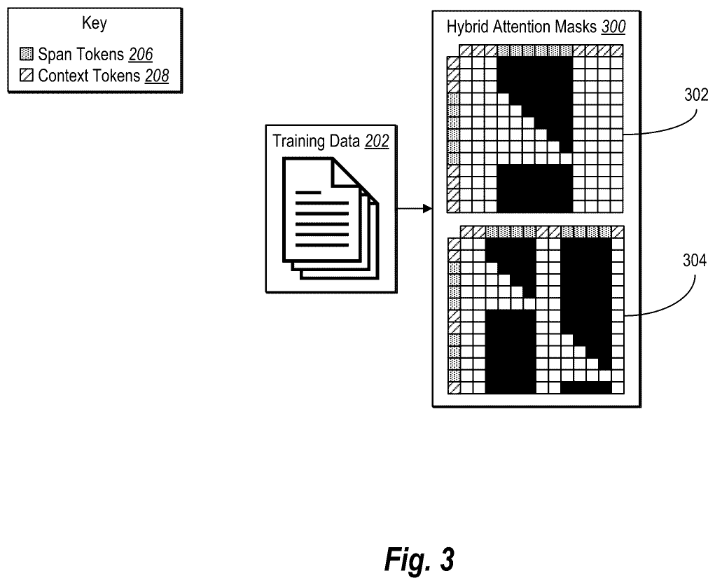

As illustrated in FIG. 2, in some implementations, the bidirectional decoder training system 106 performs an act 200 to generate context tokens and span tokens. Specifically, the bidirectional decoder training system 106 generates these context tokens and span tokens from tokens interpretable by a large language model (e.g., in training data 202), such as a large language model 212. For example, the bidirectional decoder training system 106 receives training data with tokens interpretable by the large language model 212 and uses a hybrid attention mask 204 (e.g., a causal-bidirectional hybrid attention mask) to generate span tokens 206 and context tokens 208. Indeed, the bidirectional decoder training system 106 generates span tokens 206 by using the hybrid attention mask 204 to assign a contiguous span of tokens as a set of span tokens 206. Further, in these or other embodiments, the bidirectional decoder training system 106 generates the context tokens by using the hybrid attention mask 204 to assign other tokens (e.g., surrounding the context tokens) as a set of context tokens 208. Additional detail regarding generating the span tokens 206 and the context tokens 208 is provided with respect to FIG. 3.

As further illustrated in FIG. 2, in one or more embodiments, the bidirectional decoder training system 106 performs an act 210 to modify parameters of a large language model 212 (having a decoder-only architecture). In particular, the bidirectional decoder training system 106 uses the span tokens 206 and the context tokens 208 to modify the parameters of the large language model 212 to thereby augment the functionalities of the large language model 212 (e.g., by enabling additional functions previously found only in encoder-only or encoder-decoder architectures).

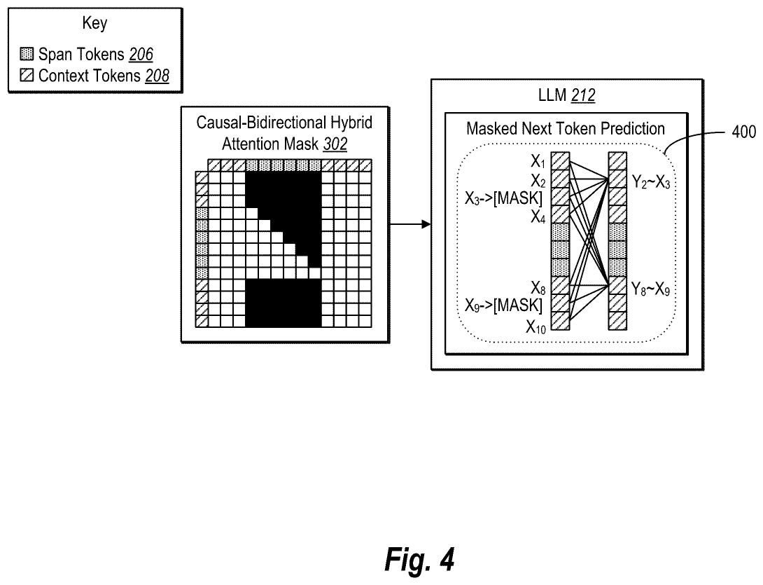

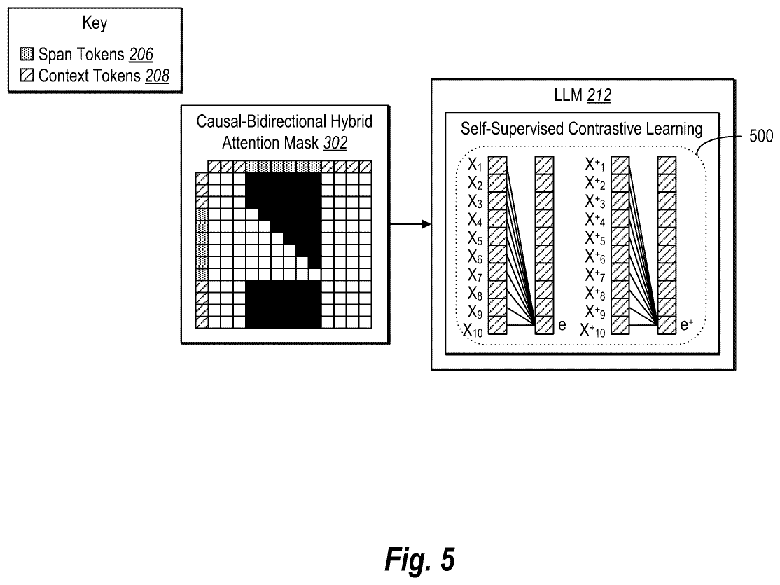

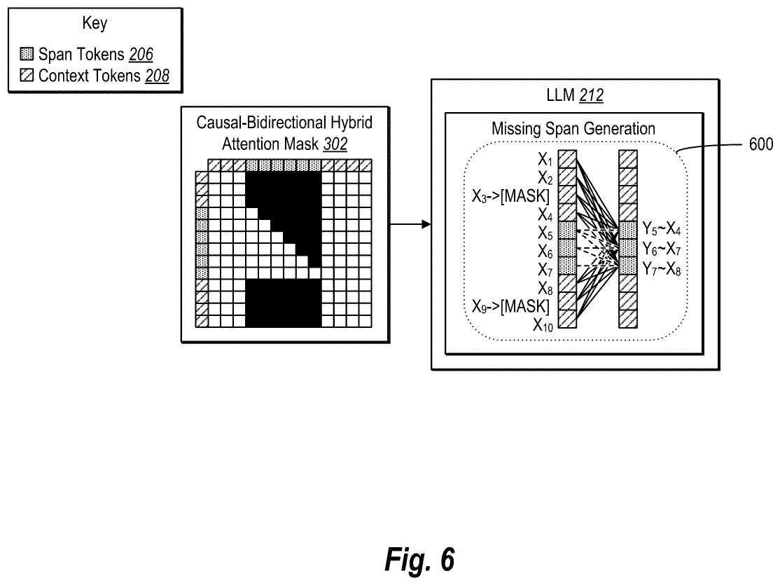

For instance, the bidirectional decoder training system 106 enables the large language model 212 (e.g., a decoder-only large language model) to perform masked next token prediction using a loss function that incorporates the context tokens 208 as described in further detail with respect to FIG. 4. Moreover, in one or more implementations, the bidirectional decoder training system 106 enables the large language model 212 to perform missing span generation using a loss function that incorporates the span tokens 206 as described in further detail with respect to FIG. 5. Furthermore, in some embodiments, the bidirectional decoder training system 106 enables the large language model 212 to perform self-supervised contrastive learning using a loss function that incorporates the context tokens 208 as described in further detail with respect to FIG. 6.

As additionally shown in FIG. 2, in some implementations, the bidirectional decoder training system 106 modifies the parameters of the large language model 212 using various training stages. Specifically, in one or more embodiments, the bidirectional decoder training system 106 modifies the parameters of the large language model 212 in a first training stage 214 and a second training stage 216. Indeed, the bidirectional decoder training system 106 modifies parameters using one set of loss functions over a first number of iterations for the first training stage 214 and modifies parameters using another set of loss functions over a second number of iterations for the second training stage 216.

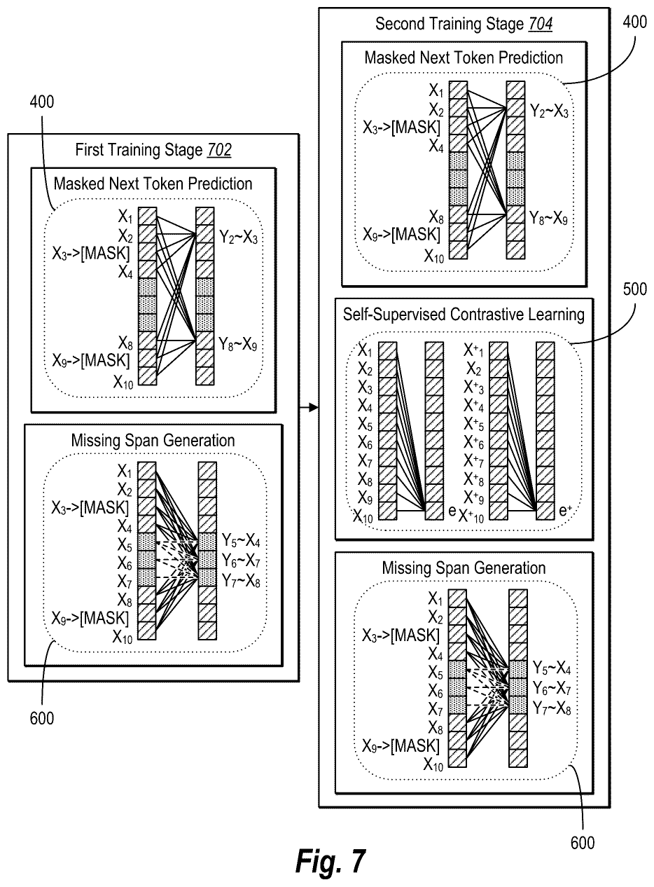

For example, the bidirectional decoder training system 106 utilizes various loss functions that incorporate the context tokens 208 and the span tokens 206 to modify the parameters in the first training stage. In this example, the bidirectional decoder training system 106 modifies the parameters of the large language model 212 to enable masked next token prediction and missing span generation in the first training stage 214. Additionally, in one or more implementations, the bidirectional decoder training system 106 utilizes the same loss functions and an additional loss function incorporating the context tokens 208 to modify the parameters in the second training stage 216. In this example, the bidirectional decoder training system 106 modifies the parameters in the second training stage 216 to enable self-supervised contrastive learning. Additional detail regarding modifying the parameters of the large language model 212 in separate training stages is provided with respect to FIG. 7.

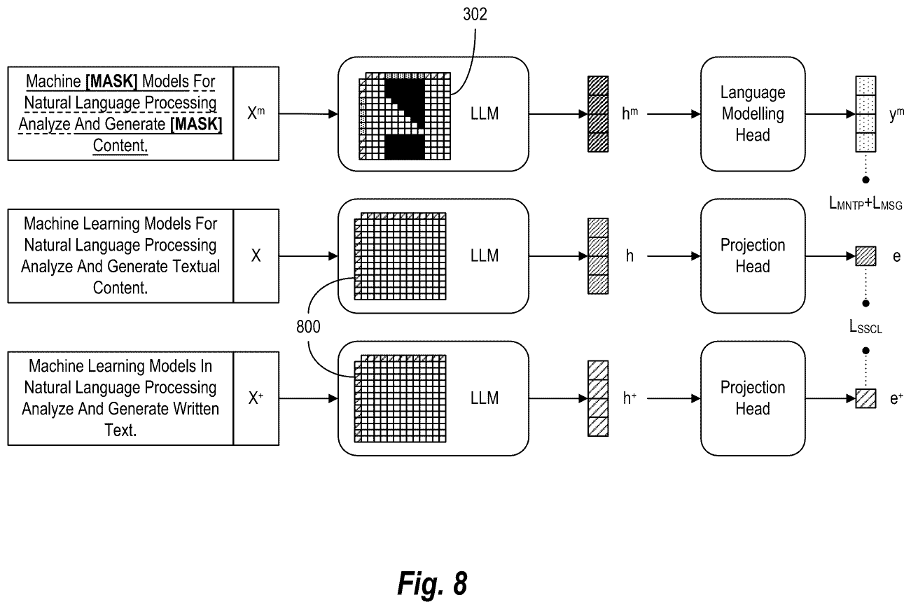

As further illustrated in FIG. 2 (e.g., with respect to the second training stage 216), in some embodiments, the bidirectional decoder training system 106 modifies the parameters of the large language model 212 to jointly enable multiple additional functions. For instance, the bidirectional decoder training system 106 utilizes a specialized training process with unique loss functions over two stages to train the large language model 212 using multiple parallel streams. Additional detail regarding modifying the parameters of the large language model 212 to enable multiple additional functions in parallel is provided with respect to FIG. 8.

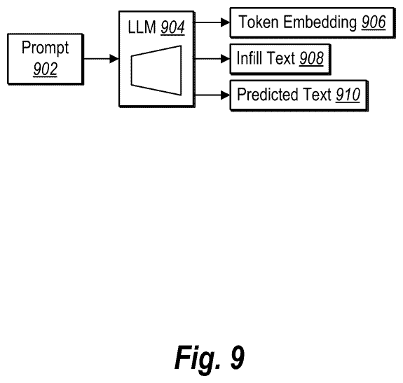

Further, in some implementations, the bidirectional decoder training system 106 uses the large language model 212 with the modified parameters to generate various outputs. Specifically, the bidirectional decoder training system 106 uses the large language model 212 with the modified parameters to generate a token embedding, infill text, and/or predicted text. For example, the bidirectional decoder training system 106 receives a prompt to the large language model 212 (e.g., a decoder-only large language model), extracts tokens from the prompt using the large language model 212, and generates the token embedding, infill text, and/or predicted text in response to the prompt. Additional detail regarding generating the various outputs using the large language model 212 with the modified parameters is provided with respect to FIG. 9.

As mentioned above, in some embodiments, the bidirectional decoder training system 106 generates a set of context tokens and a set of span tokens from tokens interpretable by a large language model. Indeed, in some implementations, the bidirectional decoder training system 106 generates the set of context tokens and span tokens using a hybrid attention mask. FIG. 3 illustrates a diagram of the bidirectional decoder training system 106 generating context tokens and span tokens using a hybrid attention mask in accordance with one or more embodiments.

As illustrated in FIG. 3, in one or more embodiments, the bidirectional decoder training system 106 uses input tokens (e.g., individual text fragments) from training data 202 to generate a set of context tokens and a set of span tokens. Specifically, the bidirectional decoder training system 106 receives the training data 202 including, or made up of, sample text (e.g., from digital documents). The bidirectional decoder training system 106 determines input tokens interpretable by a large language model from the training data 202. Further, in one or more implementations, the bidirectional decoder training system 106 uses the input tokens of the training data 202 to generate the set of context tokens with bidirectional attention and the set of span tokens with both causal attention and bidirectional attention as described further below.

As further illustrated in FIG. 3, in some embodiments, the bidirectional decoder training system 106 utilizes a hybrid attention mask 300 to generate the context tokens 208 and the span tokens 206. In some implementations, a hybrid attention mask directs the model to focus on relevant parts of a sequence of input tokens. Specifically, the hybrid attention mask differentiates between actual tokens to which the large language model should attend during attention calculations and padding tokens to which the large language model should not attend during attention calculations. Further, the hybrid attention mask includes a set of span token positions and a set of context token positions for assigning span tokens and context tokens, respectively, in a reading frame of the input tokens. For example, the hybrid attention mask includes a set of contiguous span token positions and sets of context token positions (e.g., on either side of the set of contiguous span token positions).

Indeed, in some embodiments, the bidirectional decoder training system 106 utilizes the hybrid attention mask 300 to modify the attention of the model relative to the attention of conventional decoder-only models. Specifically, conventional decoder-only models process input token sequences through a self-attention mechanism by converting the input into queries Q, keys K, and values V using linear projections. For example, conventional decoder-only models compute attention using the formula:

$${Attn}_{i} ( Q , K , V ) = softmax ( \frac{Q {K}^{T} + M}{\sqrt{{d}_{k}}} ) V$$

In this conventional attention formula, Attnᵢ is the i^{th} head of a multi-head self-attention, dk represents the dimensionality of the keys/queries, and M represents a causal mask. The causal mask M includes an upper triangle set to −∞. Thus, M ensures that the softmax operation assigns an attention weight of zero to the future positions in the sequence, which in turn ensures that each token i can only attend to itself and tokens that precede it in the sequence.

As mentioned, in one or more embodiments, the bidirectional decoder training system 106 utilizes a hybrid attention mask 300 to generate the context tokens 208 and span tokens 206. In particular, the bidirectional decoder training system 106 utilizes a single span causal-bidirectional hybrid attention mask 302 (e.g., including a single set of span tokens) or a multi-span causal-bidirectional hybrid attention mask 304 (e.g., including multiple sets of span tokens) to generate the context tokens 208 and span tokens 206.

To illustrate, the bidirectional decoder training system 106 utilizes the single span causal-bidirectional hybrid attention mask 302 to generate the context tokens 208 and the span tokens 206. Specifically, the bidirectional decoder training system 106 uses the span token positions of the single span causal-bidirectional hybrid attention mask 302 to assign a contiguous span of the input tokens as the set of span tokens 206. In this example, the bidirectional decoder training system 106 assigns six contiguous input tokens as the set of span tokens 206.

In one or more implementations, the span tokens 206 direct a large language model to focus on certain tokens (i.e., actual tokens) and not others (i.e., padding tokens) relative to the relationship of the tokens to the span tokens 206. Specifically, the span tokens 206 have causal attention with one another. Thus, each span token 206 directs the large language model to attend to only subsequent span tokens 206, capturing causal attention where tokens build on one another to cause or impact successive tokens (but do not attend to the successive tokens or other context). Moreover, in some embodiments, the span tokens 206 have bidirectional attention with the set of context tokens 208. Thus, each of the span tokens 206 directs the large language model to attend to all the context tokens 208, capturing bidirectional attention.

Indeed, the shape of the hybrid attention masks 300 indicate the causal and bidirectional attention of the span tokens 206. For example, within the mask the tokens with no fill indicate actual tokens (i.e., tokens to which the large language model should attend) and the tokens with black fill indicate padding tokens or masked tokens (i.e., tokens to which the large language model should not attend).

To further illustrate, the bidirectional decoder training system 106 uses the context token positions of the single span causal-bidirectional hybrid attention mask 302 to assign a plurality of the input tokens as the set of context tokens 208. For example, the bidirectional decoder training system 106 uses the single span causal-bidirectional hybrid attention mask 302 to assign input tokens flanking (e.g., on either side) the span tokens 206 as context tokens 208. In this example, the bidirectional decoder training system 106 assigns three or four tokens flanking the span tokens 206 on each side as context tokens 208.

In some implementations, similar to the span tokens 206, the context tokens 208 direct a large language model to focus on certain tokens (i.e., actual tokens) and not others (i.e., padding tokens) relative to the context tokens 208. Specifically, in one or more embodiments, the context tokens 208 have bidirectional attention with one another. Thus, each context tokens 208 directs the large language model to attend to all the other context tokens 208, capturing bidirectional attention. Indeed, the shape of the hybrid attention masks 300 indicate the bidirectional attention of the context tokens 208.

As additionally shown in FIG. 3, in one or more implementations, the bidirectional decoder training system 106 uses the multi-span causal-bidirectional hybrid attention mask 304 to generate the set of context tokens 208 and the set of span tokens 206 similar to the method used with the single span causal-bidirectional hybrid attention mask 302. In some embodiments, however, the bidirectional decoder training system 106 uses the multi-span causal-bidirectional hybrid attention mask 304 to assign multiple sets of contiguous spans of input tokens as multiple sets of span tokens 206.

To illustrate, the bidirectional decoder training system 106 assigns two sets of four input tokens as span tokens 206. Additionally, in this example, the bidirectional decoder training system 106 assigns one or more input tokens flanking (e.g., on either side of) each contiguous set of span tokens 206 as context tokens 208 as illustrated in FIG. 3.

In some implementations, the bidirectional decoder training system 106 utilizes the hybrid attention masks 300 to generate the span tokens 206 and the context tokens 208 for use in training large language models to augment the functionalities thereof. For example, the bidirectional decoder training system 106 utilizes the single span causal-bidirectional hybrid attention mask 302 to generate span tokens 206 and context tokens 208 to train a large language model (e.g., a decoder-only large language model) to generate infill text, a token embedding, and/or predicted text. Furthermore, in one or more embodiments, the bidirectional decoder training system 106 utilizes the multi-span causal-bidirectional hybrid attention mask 304 to generate multiple sets of span tokens 206 and context tokens 208 to train a large language model to generate infill text at multiple locations, etc. Indeed, the bidirectional decoder training system 106 utilizes the span tokens 206 and context tokens 208 to train a large language model by modifying the parameters thereof as described further below.

As noted above, in one or more implementations, the bidirectional decoder training system 106 trains a large language model by modifying the parameters thereof using span tokens and context tokens. Indeed, in some embodiments, the bidirectional decoder training system 106 uses the span tokens and context tokens generated from the hybrid attention mask to enable masked next token prediction in the large language model. FIG. 4 illustrates a diagram of the bidirectional decoder training system 106 training a large language model for masked next token prediction in accordance with one or more embodiments.

As shown in FIG. 4, in some implementations, the bidirectional decoder training system 106 trains the large language model 212 for masked next token prediction. In one or more embodiments, masked next token prediction enables the large language model 212 to utilize bidirectional attention. Specifically, masked next token prediction enables the large language model 212 to utilize bidirectional attention based on the context tokens 208 generated from a hybrid attention mask.

As mentioned, the bidirectional decoder training system 106 trains a large language model 212 for masked next token prediction. Specifically, the bidirectional decoder training system 106 trains the large language model 212 for masked next token prediction by modifying the parameters of the large language model 212. For example, as further illustrated in FIG. 4, the bidirectional decoder training system 106 trains the large language model 212 for masked next token prediction by modifying the parameters of the large language model 212 using a loss function 400 (i.e., a sub-function of an overall loss function) that incorporates the set of context tokens 208 as described further below. For instance, given a token input sequence x=(x₁, x₂, . . . , x_{L}), the bidirectional decoder training system 106 determines a fraction of the input tokens for masking. Additionally, in some embodiments, the bidirectional decoder training system 106 trains the large language model 212 to predict these masked tokens.

To illustrate, the bidirectional decoder training system 106 selects a percentage (e.g., 20%) of the input tokens for masking. In these or other embodiments, the bidirectional decoder training system 106 replaces a fraction (e.g., 80%) of the selected tokens with a [MASK] token. Further, in some implementations, the bidirectional decoder training system 106 replaces a fraction (e.g., 10%) of the selected tokens with a random token from the vocabulary of the large language model 212. Moreover, in one or more embodiments, the bidirectional decoder training system 106 leaves a remaining fraction (e.g., 10%) of the selected tokens unchanged. Furthermore, in one or more implementations, the bidirectional decoder training system 106 uses the token representations from position l to predict a masked token at position l+1.

As mentioned previously, in some embodiments, the bidirectional decoder training system 106 enables the large language model 212 to perform masked next token prediction using the loss function 400. In some implementations, the loss function 400 includes cross-entropy loss. Specifically, in one or more embodiments, the loss function 400 includes categorical cross-entropy loss. For example, the loss function 400 includes loss function L_{MNTP} as follows:

$${ℒ}_{MNTP} = - \frac{1}{N L} {\sum }_{n = 1}^{N} {\sum }_{l = 1}^{L} {\sum }_{v = 1}^{V} {𝕝}_{mask} ( l + 1 ) \cdot ( {y}_{lv}^{( n )} log ( {\hat{y}}_{lv}^{( n )} ) )$$

In the loss function [symbol] _{MNTP}, N denotes batch size, L denotes the sequence length, V denotes vocabulary size, [symbol] ₘₐₛₖ(l+1) is 1 if position l+1 is masked and 0 otherwise, and yₗᵥ and ŷₗᵥ represent the true and predicted probabilities for the v^{th} token in the vocabulary at position l in the sequence. As illustrated in FIG. 4, in one or more implementations, the loss function 400 exclusively utilizes the context tokens 208.

As noted previously, in some embodiments, the bidirectional decoder training system 106 trains a large language model by modifying the parameters thereof using span tokens and context tokens. Indeed, in some implementations, the bidirectional decoder training system 106 uses the span tokens and the context tokens generated form the hybrid attention mask to enable self-supervised contrastive learning in the large language model. FIG. 5 illustrates a diagram of the bidirectional decoder training system 106 training a large language model for self-supervised contrastive learning in accordance with one or more embodiments.

As portrayed in FIG. 5, in one or more embodiments, the bidirectional decoder training system 106 trains the large language model 212 for self-supervised contrastive learning. In one or more implementations, self-supervised contrastive learning enables the large language model 212 to capture the entire input context of an input (e.g., a prompt) to the large language model 212. For example, self-supervised contrastive learning enables the large language model 212 to capture the entire input of a prompt to generate representations of the prompt or portions of a prompt (e.g., tokens, sentences, paragraphs, etc.). Indeed, self-supervised contrastive learning enables the large language model 212 to function as an encoder without including an actual encoder as part of its architecture.

As mentioned, the bidirectional decoder training system 106 trains a large language model 212 for self-supervised contrastive learning. Specifically, the bidirectional decoder training system 106 trains the large language model 212 for self-supervised contrastive learning by modifying the parameters of the large language model 212. For example, as also depicted in FIG. 5, the bidirectional decoder training system 106 trains the large language model 212 for self-supervised contrastive learning by modifying the parameters of the large language model 212 using a loss function 500 that incorporates the set of context tokens 208 as described further below. In some embodiments, the loss function 500 is a sub-function of an overall loss function.

To illustrate, in some implementations, given an input sequence x, the bidirectional decoder training system 106 generates a corresponding augmented view x⁺. Additionally, in one or more embodiments, the bidirectional decoder training system 106 aligns the encoded representations of the input sequence x and the augmented view x⁺ as follows: e=ƒ(x) and e⁺=ƒ(x⁺) in an embedding space while distancing both from the encodings e⁻=ƒ(x) of other input sequences x⁻ in the training data. In one or more implementations, the bidirectional decoder training system 106 paraphrases text of the input sequence to vary the input (e.g., by generating augmented views of the input).

Additionally, in some embodiments, the bidirectional decoder training system 106 adds an instruction (e.g., a natural language instruction such as “Given the sentence, find its representation”) to the training examples. Further, in some implementations, the bidirectional decoder training system 106 uses the representations corresponding to the last token ([EOS]) of the final hidden states as the sentence encoding. In one or more embodiments, the bidirectional decoder training system 106 trains the large language model 212 to generate representations at multiple levels (e.g., token level, sentence level, etc.) jointly. In these or other embodiments, the bidirectional decoder training system 106 utilizes the representation of the last token to disentangle the multiple representation learning tasks during joint training.

As previously mentioned, in one or more implementations, the bidirectional decoder training system 106 enables the large language model 212 to perform self-supervised contrastive learning using the loss function 500. In some embodiments, the loss function 500 includes Noise-Contrastive Estimation loss. Specifically, in some implementations, the loss function 500 includes Information Loss Noise-Contrastive Estimation loss. For example, the loss function 500 includes loss function [symbol] _{SSCL} as follows:

$${ℒ}_{SSCL} = - \frac{1}{N} {\sum }_{i = 1}^{N} log \frac{exp ( {e}_{i} \cdot {e}_{i}^{+} / τ )}{{\sum }_{j = 1}^{N} exp ( {e}_{i} \cdot {e}_{j}^{-} / τ )}$$

In the loss function [symbol] _{SSCL}, N denotes batch size and t denotes the temperature for logit scaling. As illustrated in FIG. 5, in one or more embodiments, the loss function 500 utilizes the context tokens 208.

As previously noted, in one or more implementations, the bidirectional decoder training system 106 trains a large language model by modifying the parameters thereof using span tokens and context tokens. Indeed, in some embodiments, the bidirectional decoder training system 106 uses the span tokens and the context tokens generated form the hybrid attention mask to enable missing span generation in the large language model FIG. 6 illustrates a diagram of the bidirectional decoder training system 106 training a large language model for missing span generation in accordance with one or more embodiments.

As depicted in FIG. 6, in some implementations, the bidirectional decoder training system 106 trains the large language model 212 for missing span generation. In one or more embodiments, missing span generation enables the large language model 212 to predict and fill in gaps or missing portions of text within an input (e.g., as part of a prompt to the large language model 212). For example, missing span generation enables the large language model 212 to understand the surrounding context and generate text that logically and coherently completes the missing portions. Indeed, once trained for missing span generation, the large language model 212 is capable of generating infill text, for example, in response to a prompt including a text infilling request.

As mentioned, the bidirectional decoder training system 106 trains a large language model 212 for missing span generation. Specifically, the bidirectional decoder training system 106 trains the large language model 212 for missing span generation by modifying the parameters of the large language model 212. For example, as further illustrated in FIG. 6, the bidirectional decoder training system 106 trains the large language model 212 for missing span generation by modifying the parameters of the large language model 212 using a loss function 600 that incorporates the set of span tokens 206 as discussed further below. In one or more implementations, the loss function 600 is a sub-function of an overall loss function.

To illustrate, in some embodiments, given a position p and an input sequence X=(x₁, . . . , xₚ, x_{q}, . . . , x_{L}), the bidirectional decoder training system 106 trains the large language model 212 to generate a plausible sequence of m tokens y=(y₁, y₂, . . . , yₘ) that fits between xₚ and x_{q}. More specifically, the bidirectional decoder training system 106 predicts a span token yₗ conditioned on all context tokens 208 in x and the preceding span tokens x_{[1 . . . l-1]}.

As mentioned above, in some implementations, the bidirectional decoder training system 106 enables the large language model 212 to perform missing span generation using the loss function 600. In one or more embodiments, the loss function 600 includes cross-entropy loss. Specifically, in one or more implementations, the loss function 600 includes categorical cross-entropy loss wherein the bidirectional decoder training system 106 computes the loss over the predicted span tokens 206. For example, the loss function 600 includes loss function [symbol] _{MSG} as follows:

$${ℒ}_{MSG} = - \frac{1}{N} {\sum }_{n = 1}^{N} {\sum }_{l = 1}^{L} {\sum }_{v = 1}^{V} {𝕝}_{span} ( l ) \cdot ( {y}_{lv}^{( n )} log ( {\hat{y}}_{lv}^{( n )} ) )$$

In the loss function [symbol] _{MSG}, N denotes batch size, L denotes sequence length, V denotes vocabulary size, [symbol] ₛₚₐₙ(l) is 1 if the token at position l is a span token and 0 otherwise, and yₗᵥ and ŷₗᵥ represent the true and predicted probabilities for token v in the vocabulary at position l in the sequence. Additionally, in some embodiments, the bidirectional decoder training system 106 uses the loss function 600 to modify the parameters of the large language model 212 to retain the original text generation capability (e.g., generating predicted text from left to right) of the large language model 212.

As noted above, in some implementations, the bidirectional decoder training system 106 utilizes multiple training stages to train the large language model. Indeed, in one or more embodiments, the bidirectional decoder training system 106 modifies the parameters of the large language model at different training stages to train the large language model for additional functionalities. FIG. 7 illustrates a diagram of the bidirectional decoder training system 106 training the large language model for additional functions at multiple training stages in accordance with one or more embodiments.

As illustrated in FIG. 7, in one or more implementations, the bidirectional decoder training system 106 trains the large language model for additional functions at a first training stage 702. In some embodiments, a training stage includes a specific phase in the overall training process. In particular, a training stage includes repeated iterations of adjusting the parameters of the large language model. Moreover, in some implementations, a training stage includes modifying the parameters according to a particular task or objective. For example, a training stage includes modifying the parameters to enable and/or retain one or more additional or existing functionalities such as masked next token prediction, self-supervised contrastive learning, or missing span generation. In some cases, a first training stage comes before a second training stage where the bidirectional decoder training system 106 trains over a set of iterations at the first stage before training over another set of iterations at the second stage.

As mentioned previously, in one or more embodiments, the bidirectional decoder training system 106 trains the large language model for additional functions at the first training stage 702. Specifically, as additionally shown in FIG. 7, the bidirectional decoder training system 106 modifies the parameters of the large language model at the first training stage 702 according to multiple training objectives. For example, the bidirectional decoder training system 106 utilizes a first loss function, e.g., a masked next token prediction loss function, to modify the parameters. Indeed, in these or other embodiments, the bidirectional decoder training system 106 utilizes the loss function 400 (which incorporates the context tokens) in the first training stage 702 as part of enabling masked next token prediction in the large language model.

As further illustrated in FIG. 7, in one or more implementations, the bidirectional decoder training system 106 modifies the parameters of the large language model at the first training stage 702 according to a second training objective. In particular, the bidirectional decoder training system 106 utilizes a second loss function, e.g., a missing span generation loss function, to modify the parameters. In these or other embodiments, the bidirectional decoder training system 106 utilizes the loss function 600 (which incorporates the span tokens) in the first training stage 702 as part of enabling missing span generation in the large language model.

Furthermore, in some embodiments, the bidirectional decoder training system 106 modifies the parameters at the first training stage 702 by omitting a third loss function. Specifically, the bidirectional decoder training system 106 omits a self-supervised contrastive learning loss function (e.g., loss function 500) in the first training stage 702. Additionally, in some implementations, the bidirectional decoder training system 106 modifies the parameters of the large language model in the first training stage 702 over a number of iterations before the second training stage. For example, in one or more embodiments, the bidirectional decoder training system 106 modifies the parameters in the first training stage 702 over 3,400 iterations.

To illustrate, in one or more implementations, the bidirectional decoder training system 106 utilizes an overall loss function at the first training stage 702 and the second training stage 704, applying different λ values for each stage to adjust the weight or impact of the constituent internal loss functions. Indeed, as shown below, the overall loss function incorporates other loss functions as sub-functions. For example, the bidirectional decoder training system 106 uses the overall loss function [symbol] :

$$ℒ = {λ}_{1} {ℒ}_{MNTP} + {λ}_{2} {ℒ}_{SSCL} + {λ}_{3} {ℒ}_{M S G}$$

As mentioned, in some implementations, the bidirectional decoder training system 106 applies different λ values for each stage to adjust the weight or impact of the constituent internal loss functions of the overall loss function. For example, in some embodiments, the bidirectional decoder training system 106 sets λ₁ and λ₃ to 1 and sets λ₂ to 0 in the first training stage 702. Thus, in these or other embodiments, the bidirectional decoder training system 106 utilizes the masked next token prediction loss function and the missing span generation loss function while omitting the self-supervised contrastive learning loss function in the first training stage 702.

As also depicted in FIG. 7, in some implementations, the bidirectional decoder training system 106 trains the large language model for additional functions at a second training stage 704. Specifically, the bidirectional decoder training system 106 modifies the parameters of the large language model at the second training stage 704 according to multiple training objectives. For example, the bidirectional decoder training system 106 modifies the parameters using a third loss function in addition to the first and second loss functions (i.e., the masked next token prediction loss function such as loss function 400 and the missing span generation loss function such as loss function 600). In particular, the bidirectional decoder training system 106 utilizes the third loss function such as a self-supervised contrastive learning loss function to modify the parameters. Indeed, in these or other embodiments, the bidirectional decoder training system 106 utilizes the loss function 500 (which incorporates the context tokens) as part of enabling self-supervised contrastive learning in the large language model.

To illustrate, the bidirectional decoder training system 106 utilizes the overall loss function [symbol] described above to modify the parameters in the second training stage 704. Specifically, in one or more embodiments, the bidirectional decoder training system 106 sets λ₁ and λ3 to 1 and sets λ₂ to 9 in the second training stage 704. The bidirectional decoder training system 106 thus weights the self-supervised contrastive learning loss function more heavily in the second training stage 704 (e.g., 9 to 1 relative to the other loss functions). In one or more implementations, the bidirectional decoder training system 106 modifies the parameters using the first, second, and third loss functions over a number of iterations (e.g., 800 iterations) in the second training stage 704.

As noted previously, in some embodiments, the bidirectional decoder training system 106 trains the large language model according to multiple training objectives such as adding functionalities. Indeed, in some implementations, the bidirectional decoder training system 106 trains the large language model to add functionalities simultaneously. FIG. 8 illustrates a diagram of the bidirectional decoder training system 106 simultaneously training the large language model according to multiple training objectives in accordance with one or more embodiments.

As shown in FIG. 8, in one or more embodiments, the bidirectional decoder training system 106 begins with a training example x. Additionally, in one or more implementations, the bidirectional decoder training system 106 proceeds in two parallel streams. Specifically, in a first stream, the bidirectional decoder training system 106 generates form x^{m} by marking one or more spans of contiguous tokens M as span tokens while masking a fraction of the remaining tokens as context tokens to generate a causal-bidirectional hybrid attention mask 302. As shown with form x^{m}, “Machine [MASK] models” and “and generate [MASK] content” have solid underlining indicating they are associated with the context tokens while “for natural language processing analyze” has dashed underlining indicating it is associated with the span tokens. Further, in some embodiments, in a second stream, the bidirectional decoder training system 106 augments the training example x to get x⁺.

As further illustrated in FIG. 8, in some implementations, the bidirectional decoder training system 106 generates hidden states in parallel. In particular, the bidirectional decoder training system 106 proceeds by generating hidden states h, h^{m}, and h⁺ in parallel (each of which are associated with the context tokens as indicated in FIG. 8), from x, x^{m}, and x⁺, respectively. For instance, the bidirectional decoder training system 106 processes x, x^{m}, and x⁺ using different attention mechanisms within the large language model. In these or other embodiments, the bidirectional decoder training system 106 utilizes the large language model with the causal-bidirectional hybrid attention mask 302 to generate the hidden state h^{m} from x^{m} as shown. Moreover, the bidirectional decoder training system 106 utilizes the large language model with a bidirectional attention mask 800 to generate h and h⁺ from x and x⁺ respectively, as shown.

As additionally shown in FIG. 8, in one or more embodiments, the bidirectional decoder training system 106 generates the loss functions. Specifically, the bidirectional decoder training system 106 uses a language modeling head to generate y^{m} (which is associated with the span tokens as indicated in FIG. 8). Furthermore, in one or more implementations, the bidirectional decoder training system 106 uses y^{m} to generate a masked next token prediction loss function (e.g., [symbol] _{MNTP}) and a missing span generation loss function (e.g., [symbol] _{MSG}). Additionally, in some embodiments, the bidirectional decoder training system 106 use a projection head to generate e and e⁺ from h and h⁺, respectively. In these or other embodiments, the bidirectional decoder training system 106 uses e and e⁺ (each of which are associated with the context tokens as shown in FIG. 8) to generate a self-supervised contrastive learning loss function (e.g., [symbol] _{SSCL}). Further, the bidirectional decoder training system 106 generates the overall loss function [symbol] , as described above, from the masked next token prediction loss function, the missing span generation loss function, and the self-supervised contrastive learning loss function. In some implementations, the bidirectional decoder training system 106 marks all input tokens as span tokens. In these or other embodiments, the bidirectional decoder training system 106 utilizes a causal attention mask.

As previously mentioned, in one or more embodiments, the bidirectional decoder training system 106 uses a decoder-only large language model with modified parameters to generate various different types of outputs. Indeed, in one or more implementations, the bidirectional decoder training system 106 uses the decoder-only large language model with parameters modified according to the loss functions described above to generate the different types of outputs. FIG. 9 illustrates a diagram of the bidirectional decoder training system 106 using a decoder-only large language model to generate a token embedding, an infill text, and/or predicted text in accordance with one or more embodiments.

As portrayed in FIG. 9, in some embodiments, the bidirectional decoder training system 106 receives a prompt 902. Specifically, the bidirectional decoder training system 106 receives the prompt 902 from a client device via a graphical user interface of the client device. For example, the bidirectional decoder training system 106 receives a prompt 902 including text which the bidirectional decoder training system 106 converts into tokens (e.g., using the large language model 904). Further, in some implementations, the prompt 902 includes a request such as an encoding request, a text infilling request, or a text generation request.

In one or more embodiments, an encoding request includes a request that requires a large language model to analyze input data to capture the semantic meaning of the input data (e.g., a portion of the input such as a token, a sentence, etc.) and to encode the data. Specifically, an encoding request requires the large language model to generate an embedding of the data in a latent space, for example, for comparison with other embeddings. For example, an encoding request requires the large language model to generate an embedding (e.g., a token embedding) that serves as a condensed representation of the input data (e.g., the token), capturing the relationships and context thereof within the text of the input in a high-dimensional vector space.

Moreover, in one or more implementations, a text infilling request includes a request that the large language model complete or generate missing portions within an input text. Specifically, a text infilling request requires the large language model to interpret the surrounding context on both sides of the missing portion (e.g., missing words) of the input text and generate coherent text (i.e., infill text) for filling the gap. For example, a text infilling request prompts the large language model to generate infill text such as one or more words, phrases, sentences, etc. to replace missing text in the input text.

Furthermore, in some embodiments, a text generation request includes a request that the large language model generate new text based on an initial input (e.g., in the prompt). In particular, the text generation request includes a request that the large language model predict text from left to right such as by predicting one or more tokens at a time from left to right. For example, a text generation request includes predicting sentences, paragraphs, or other structured text (i.e., generating predicted text).

Additionally, in some implementations, the bidirectional decoder training system 106 extracts a plurality of tokens from the prompt 902. Specifically, the bidirectional decoder training system 106 extracts the tokens using a decoder-only large language model 904 to process the prompt. In these or other embodiments, the bidirectional decoder training system 106 has previously modified the parameters of the decoder-only large language model 904 based on one or more loss functions that incorporate causality and bidirectionality. Indeed, in one or more embodiments, the bidirectional decoder training system 106 has modified the parameters of the decoder-only large language model 904 according to one or more of the loss functions previously discussed. For example, the bidirectional decoder training system 106 has modified the parameters of the decoder-only large language model 904 based on the loss function (e.g., the self-supervised contrastive learning loss function) incorporating causality via the span tokens. Further, in one or more implementations, the bidirectional decoder training system 106 has modified the parameters of the decoder-only large language model 904 based on the loss functions (e.g., the masked next token prediction loss function and/or the missing span generation loss function) incorporating bidirectionality via the context tokens.

As further illustrated in FIG. 9, in some embodiments, the bidirectional decoder training system 106 uses the decoder-only large language model 904 with modified parameters to generate one or more outputs. In particular, the bidirectional decoder training system 106 generates a token embedding 906 using the decoder-only large language model 904 in response to an encoding request. For example, the bidirectional decoder training system 106 uses the decoder-only large language model 904 with self-supervised contrastive learning enabled as described above to generate the token embedding 906. Moreover, in some implementations, the bidirectional decoder training system 106 generates infill text 908 using the decoder-only large language model 904 in response to a text infilling request. For instance, the bidirectional decoder training system 106 uses the decoder-only large language model 904 with missing span generation enabled as described above to generate the infill text 908. Furthermore, in one or more embodiments, the bidirectional decoder training system 106 generates predicted text 910 using the decoder-only large language model 904 in response to a text generation request. For example, the bidirectional decoder training system 106 generates the predicted text 910 using the decoder-only large language model 904 including parameters modified based on the overall loss function comprising the three loss sub-functions that enable causal attention and bidirectional attention.

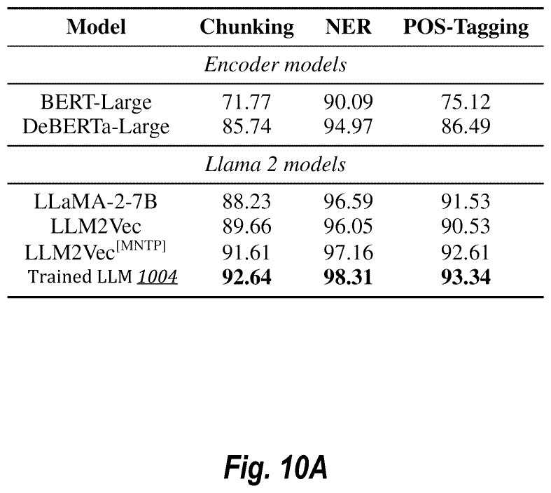

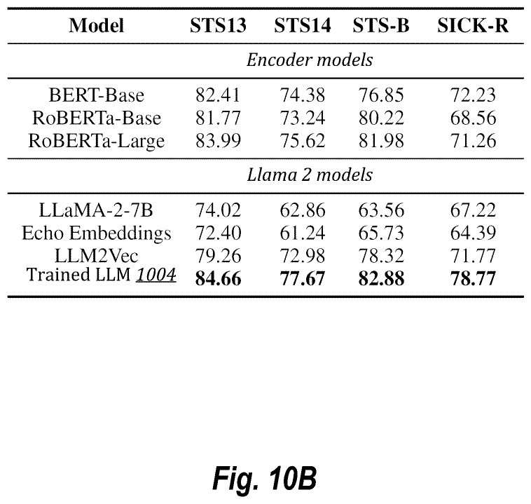

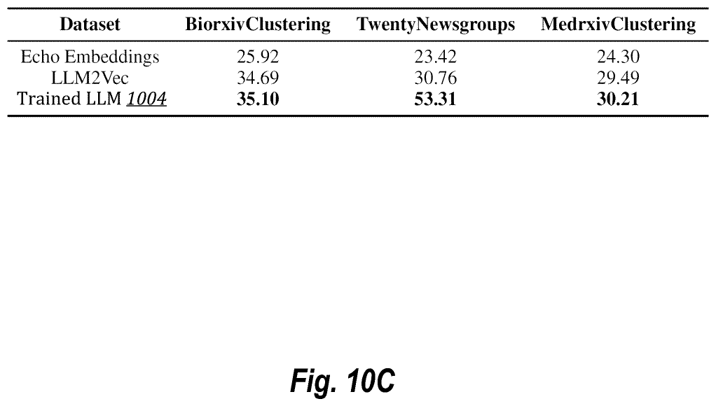

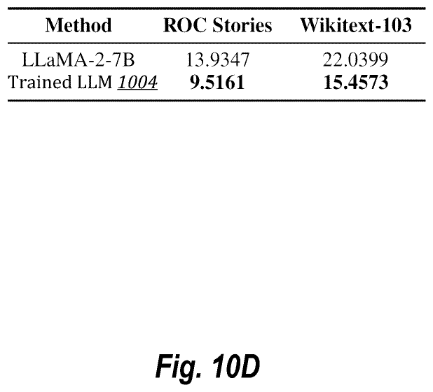

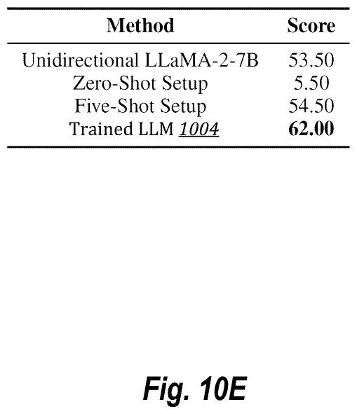

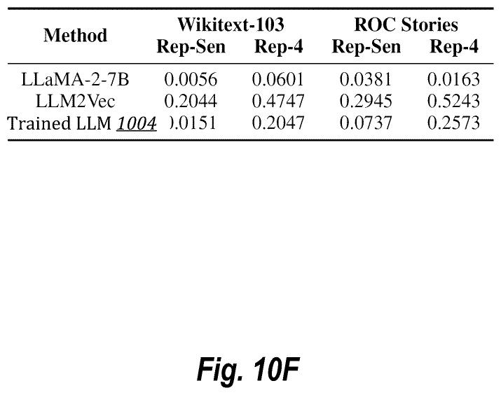

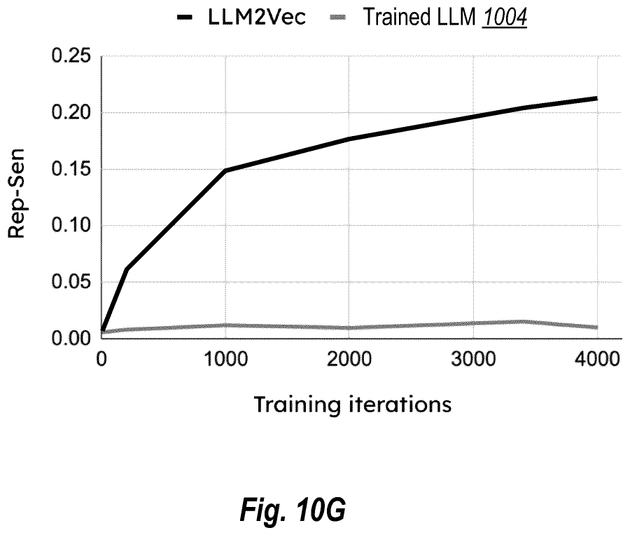

As mentioned above, in some implementations, the bidirectional decoder training system 106 improves the flexibility and accuracy of large language models, particularly decoder-based or decoder-only large language models. Indeed, in one or more embodiments, the bidirectional decoder training system 106 improves the flexibility and accuracy of such models by training these models to generate embeddings and text infill while maintaining the traditional decoder functionality of generating text. FIGS. 10A-10G illustrate augmented functionality results achieved by a decoder-only large language model trained using the bidirectional decoder training system 106 compared with example functionality results of conventional models in accordance with one or more embodiments.

As illustrated in FIGS. 10A-10C, the bidirectional decoder training system 106 trains a large language model (e.g., a decoder-only large language model) to include the augmented functionality of representation learning (e.g., generating embeddings). Indeed, as shown in FIG. 10A, the trained large language model 1004 trained by the bidirectional decoder training system 106 outperforms other models at generating word-level representations. Specifically, the trained large language model 1004 outperforms state-of-the-art encoder models as well as Llama 2 models adapted to representation learning, as indicated by the percentage scores of the table where higher scores denote better accuracy. For example, the trained large language model 1004 outperforms each of these models at three tasks including chunking, named entity recognition (NER), and part-of-speech (POS) tagging.

As shown in FIGS. 10B and 10C, in one or more implementations, the bidirectional decoder training system 106 trains a large language model to outperform other models at generating sentence-level representations, as indicated by the percentage scores of the tables where higher scores denote better accuracy. In particular, the trained large language model 1004 outperforms both encoder models and Llama 2 models adapted as text encoders. For instance, the trained large language model 1004 outperforms each of these models on semantic textual similarity (STS) tasks. Further, as shown in FIG. 10C, the trained large language model 1004 outperforms each of the other models on clustering tasks using the various dataset as illustrated.

As portrayed in FIGS. 10D and 10E, in some embodiments, the bidirectional decoder training system 106 trains a large language model to include the augmented functionality of text infilling. Indeed, as illustrated in FIG. 10D, the trained the large language model 1004 (e.g., LLaMA-2-7B trained using the bidirectional decoder training system 106 in the examples of FIGS. 10D and 10E) outperforms other models at text infilling, as indicated by the percentage scores of the tables where higher scores denote better accuracy. Specifically, the trained large language model 1004 outperforms LLaMA-2-7B at generating text infills for randomly masked sentences from each of ROC Stories (a dataset of 50,000 short, five-sentence stories) and Wikitext-103 (a dataset that consists of over 100 million tokens extracted from verified Good and Featured articles on Wikipedia). Indeed, LLaMA-2-7B shows significantly higher perplexity compared to the trained large language model 1004.

As depicted in FIG. 10E, in some implementations, the trained large language model 1004 outperforms LLaMA-2-7B and zero-shot and five-shot variations thereof. In this example, LLaMA-2-7B was enabled to incorporate all the surrounding context when infilling a missing span using a zero-shot setup and a five-shot setup. Indeed, as shown in FIG. 10E, the bidirectional decoder training system 106 scored significantly higher at generating contextually appropriate sentences that contributed to a coherent story than any of the other models tested. In this example, each of the of the models generated a sentence to replace masked sentences from 100 randomly sampled stories from the ROC Stories dataset and was evaluated by human annotators.

As illustrated in FIGS. 10F and 10G, in one or more embodiments, the bidirectional decoder training system 106 trains a large language model to retain the functionality of generating text (e.g., from left to right). For background, generative decoder models exhibit a repetition problem by repeatedly producing the same phrases or sentences when generating text (often at low frequency). When generative decoder models are adapted into text encoders by enabling bidirectional attention, repetition is significantly worsened. Further, the repetition problem often worsens with additional iterations of training.

As illustrated in FIG. 10F, compared to LLM2Vec (a text encoding adaptation of LLaMA-2-7B) the trained large language model 1004 (e.g., LLaMA-2-7B trained using the bidirectional decoder training system 106 in the examples of FIGS. 10F and 10G) has significantly fewer repetitions. In FIG. 10F, Rep-Sen and Rep-4 are repetition metrics wherein lower numbers correspond to fewer repetitions, where:

$$Rep - Sen = 1.0 - \frac{\vert unique sentences \vert}{\vert sentences \vert} and$$

$$Rep - n = 1.0 - \frac{\vert unique n - grams \vert}{\vert n - grams \vert} .$$

As shown in FIG. 10G, the trained large language model 1004 maintains the ability to generate text with few repetitions over many training iterations whereas LLM2Vec follows the typical trend of growing repetition over increasing training iterations.

Turning to FIG. 11, additional detail will now be provided regarding various components and capabilities of the bidirectional decoder training system 106. In particular, FIG. 11 illustrates an example schematic diagram of a computing device 1100 (e.g., the server device(s) 102 and/or the client device(s) 110) implementing the bidirectional decoder training system 106 in accordance with one or more embodiments of the present disclosure for components 1100-1106. As illustrated in FIG. 11, the bidirectional decoder training system 106 includes an attention mask manager 1102, a model training manager 1104, a large language model 904, and data storage 1106.

The attention mask manager 1102 receives tokens, such as input tokens, interpretable by a large language model. For example, the attention mask manager 1102 receives tokens that are part of a training data set. Additionally, the attention mask manager 1102 utilizes the input tokens to generate a set of context tokens comprising tokens with bidirectional attention. Further, the attention mask manager 1102 utilizes the input tokens to generates a set of span tokens comprising tokens with causal attention and with bidirectional attention. Moreover, the attention mask manager 1102 interacts with other components to pass the context tokens and span tokens for further processing.

The model training manager 1104 trains the large language model 904. For example, the model training manager 1104 receives the context tokens and the span tokens from the attention mask manager 1102. Furthermore, the model training manager 1104 modifies the parameters of the large language model 904 by utilizing a first loss function that incorporates the set of context tokens, a second loss function that incorporates the set of span tokens, and a third loss function that incorporates the set of context tokens. For instance, the model training manager 1104 uses the first loss function to enable masked next token prediction, the second loss function to enable missing span generation, and the third loss function to enable self-supervised contrastive learning. Additionally, in one or more implementations, the model training manager 1104 modifies the parameters of the large language model 904 at multiple training stages. For example, the model training manager 1104 modifies the parameters of the large language model 904 at a first training stage using the first loss function and the second loss function. Further, the model training manager modifies the parameters of the large language model at a second training stage using the first, second, and third loss functions. Moreover, the model training manager 1104 provides the trained large language model 904 to generate outputs.

The trained large language model 904 (e.g., a decoder-only large language model 904) receives a prompt comprising at least one of an encoding request, a text infilling request, and/or a text generation request. Furthermore, the trained large language model 904 extracts tokens from the prompt to process the prompt. For example, the trained large language model 904 processes the prompt according to the modified parameters based on the first, second, and third loss functions which incorporate causality and bidirectionality. Additionally, the trained large language model 904 generates outputs in response to the encoding request, text infilling request, and/or text generation request. For example, the trained large language model 904 generates a token embedding from the tokens extracted from the prompt based on the encoding request, an infill text based on the text infilling request, and/or predicted text based on the text generation request.

The data storage 1106 stores digital text, digital documents, generated tokens, functions, generated outputs etc. For example, the data storage 1106 stores training data including tokens, input text (e.g., from a prompt) various datasets and stores. Further, the data storage 1106 stores tokens generated from input text, training data tokens, generated input and span tokens, generated outputs such as those in response to requests in a prompt to a trained large language model, as well as functions such as loss functions and/or sub-functions of loss functions utilized by the bidirectional decoder training system 106.

In some embodiments, each of the components 1102-1106 of the bidirectional decoder training system 106 include software, hardware, or both. For example, the components 1102-1106 include one or more instructions stored on a computer-readable storage medium and executable by processors of one or more computing devices, such as a client device or server device. When executed by the one or more processors, the computer-executable instructions of the bidirectional decoder training system 106 cause the computing device(s) to perform the methods described herein. Alternatively, the components 1102-1106 include hardware, such as a special-purpose processing device to perform a certain function or group of functions. Alternatively, the components 1102-1106 of the bidirectional decoder training system 106 include a combination of computer-executable instructions and hardware.

Furthermore, the components 1102-1106 of the bidirectional decoder training system 106 are, for example, implemented as one or more operating systems, as one or more stand-alone applications, as one or more modules of an application, as one or more plug-ins, as one or more library functions or functions that may be called by other applications, and/or as a cloud-computing model. Thus, in various embodiments, the components 1102-1106 of the bidirectional decoder training system 106 are implemented as a stand-alone application, such as a desktop or mobile application. Furthermore, in various embodiments, the components 1102-1106 of the bidirectional decoder training system 106 are implemented as one or more web-based applications hosted on a remote server. Alternatively, or additionally, the components 1102-1106 of the bidirectional decoder training system 106 are implemented in a suite of mobile device applications or “apps.” For example, in one or more embodiments, the bidirectional decoder training system 106 comprises or operates in connection with digital software applications such as ADOBE® EXPRESS®, ADOBE® FIREFLY®, and/or ADOBE® PHOTOSHOP® CREATIVE CLOUD®.

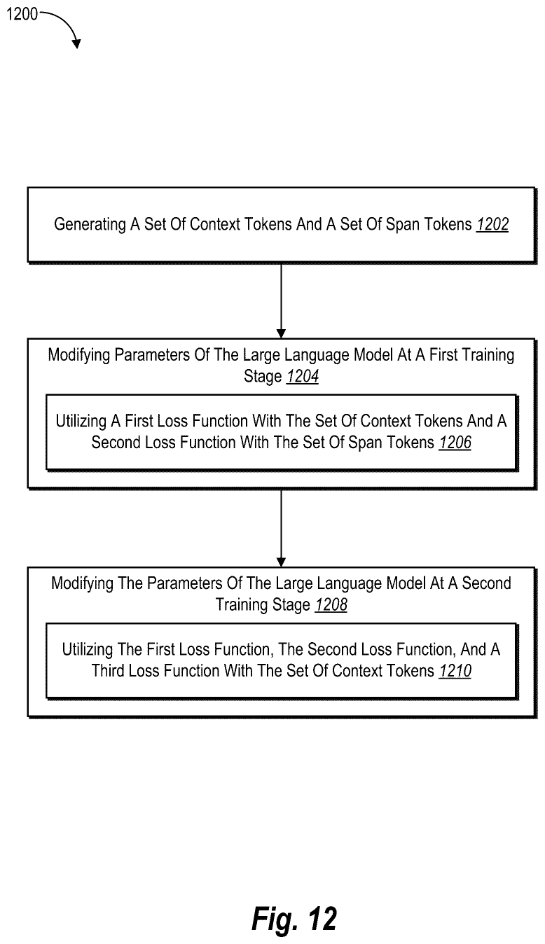

FIGS. 1-10, the corresponding text, and the examples provide a number of different systems, methods, and non-transitory computer readable media for modifying parameters of a large language model and generating a token embedding or infill text using the large language model with modified parameters. In addition to the foregoing, embodiments can also be described in terms of flowcharts comprising acts for accomplishing a particular result. For example, FIGS. 12-14 illustrate flowcharts of example sequences of acts in accordance with one or more embodiments.

While FIGS. 12-14 illustrate acts according to some embodiments, alternative embodiments may omit, add to, reorder, and/or modify any of the acts shown in FIGS. 12-14. The acts of FIGS. 12-14 can be performed as part of a method. Alternatively, a non-transitory computer readable medium can comprise instructions, that when executed by one or more processors, cause a computing device to perform the acts of FIGS. 12-14. In still further embodiments, a system can perform the acts of FIGS. 12-14. Additionally, the acts described herein may be repeated or performed in parallel with one another or in parallel with different instances of the same or other similar acts.

FIG. 12 illustrates an example series of acts 1200 for modifying parameters of a large language model using varying combinations of loss functions at separate training stages. In some implementations, the series of acts 1200 includes an act 1202 of generating a set of context tokens and a set of span tokens; an act 1204 of modifying parameters of the large language model at a first training stage; an act 1206 of utilizing a first loss function with the set of context tokens and a second loss function with the set of span tokens; an act 1208 of modifying the parameters of the large language model at a second training stage; and an act 1210 of utilizing the first loss function, the second loss function, and a third loss function with the set of context tokens.

In some embodiments, the act 1202 also includes generating from a plurality of tokens interpretable by a large language model a set of context tokens including tokens with bidirectional attention and a set of span tokens including tokens with causal attention and bidirectional attention. In some implementations, the act 1204 further includes an act of modifying parameters of the large language model at a first training stage by utilizing a first loss function that incorporates the set of context tokens and a second loss function that incorporates the set of span tokens. Additionally, in one or more embodiments, the act 1208 also includes an act of modifying the parameters of the large language model at a second training stage by utilizing the first loss function, the second loss function, and a third loss function that incorporates the set of context tokens.

In some implementations, generating the set of span tokens includes assigning, utilizing a causal-bidirectional hybrid attention mask, a contiguous span of tokens of the plurality of tokens interpretable by the large language model to have causal attention with one another. In one or more embodiments, generating the set of span tokens includes assigning, utilizing a causal-bidirectional hybrid attention mask, a contiguous span of tokens of the plurality of tokens interpretable by the large language model to have bidirectional attention with the set of context tokens.

In one or more implementations, generating the set of context tokens includes assigning, utilizing a causal-bidirectional hybrid attention mask, non-contiguous tokens of the plurality of tokens interpretable by the large language model to have bidirectional attention with one another. In some embodiments, the second loss function enables the large language model to perform missing span generation by modifying the parameters of the large language model using the set of span tokens, the large language model including a decoder-only large language model.

In some implementations, the first loss function enables the large language model to perform masked next token prediction by modifying the parameters of the large language model using the set of context tokens. In one or more embodiments, the third loss function enables the large language model to perform self-supervised contrastive learning by modifying the parameters of the large language model using the set of context tokens, the large language model including a decoder-only large language model.

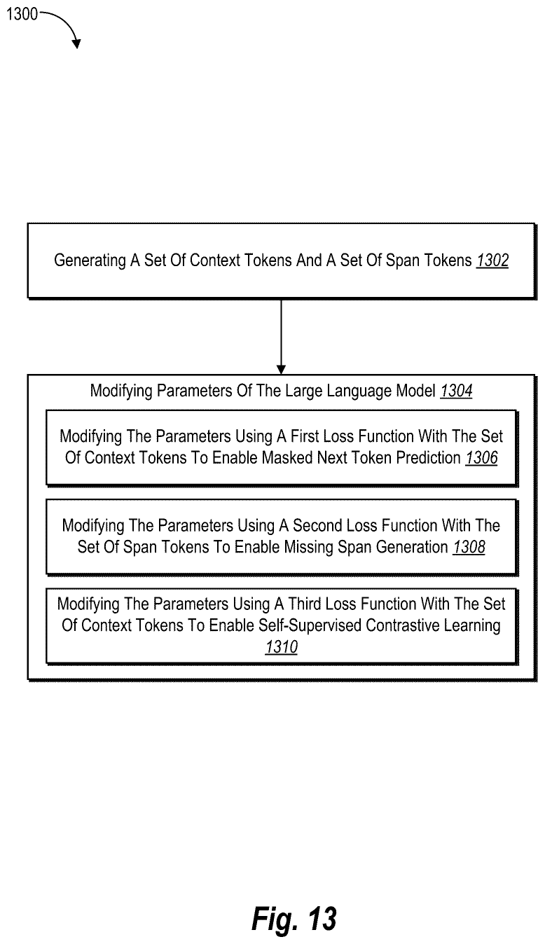

FIG. 13 illustrates an example series of acts 1300 for modifying parameters of a large language model using a series of loss functions incorporating context tokens and span tokens. In one or more embodiments, the series of acts 1300 includes an act 1302 of generating a set of context tokens and a set of span tokens; an act 1304 of modifying parameters of the large language model; an act 1306 of modifying the parameters using a first loss function with the set of context tokens to enable masked next token prediction; an act 1308 of modifying the parameters using a second loss function with the set of span tokens to enable missing span generation; and an act 1310 of modifying the parameters using a third loss function with the set of context tokens to enable self-supervised contrastive learning.

In one or more implementations, the act 1302 also includes generating, from a plurality of tokens interpretable by a large language model, a set of context tokens capturing bidirectional attention and a set of span tokens capturing causal attention. In one or more implementations, the act 1306 also includes an act of modifying parameters of the large language model according to a first loss function that incorporates the set of context tokens and that enables masked next token prediction by the large language model. In some embodiments, the act 1308 further includes an act of modifying the parameters of the large language model according to a second loss function that incorporates the set of span tokens and that enables missing span generation by the large language model. Additionally, in some implementations, the act 1308 also includes an act of modifying the parameters of the large language model according to a third loss function that incorporates the set of context tokens and that enables self-supervised contrastive learning by the large language model.

In some embodiments, the series of acts 1300 includes generating the set of span tokens capturing causal attention by assigning, utilizing a causal-bidirectional hybrid attention mask, a contiguous span of tokens of the plurality of tokens interpretable by the large language model to have causal attention with one another. In one or more embodiments, the series of acts 1300 also includes an act of generating the set of context tokens capturing bidirectional attention by assigning, utilizing the causal-bidirectional hybrid attention mask, additional tokens of the plurality of tokens flanking the set of span tokens and attending to one another.

In some implementations, the series of acts 1300 includes generating the set of span tokens capturing bidirectional attention by assigning, utilizing the causal-bidirectional hybrid attention mask, one or more tokens of the set of span tokens to have bidirectional attention to the set of context tokens. In one or more embodiments, modifying the parameters of the large language model according to the first loss function includes modifying the parameters of the large language model at a first training stage that involves modifying the parameters of the large language model over a number of iterations before a second training stage.

In one or more implementations, modifying the parameters of the large language model according to the third loss function includes modifying the parameters of the large language model at a first training stage that involves modifying the parameters of the large language model over a number of iterations before a second training stage. In some embodiments, modifying the parameters of the large language model according to the second loss function includes modifying the parameters of the large language model at a second training stage that involves modifying the parameters of the large language model over a number of iterations after a first training stage.

In some implementations, modifying the parameters of the large language model includes modifying parameters at a first training stage that incorporates the first loss function and the second loss function and omits the third loss function. In one or more implementations, the series of acts 1300 further includes an act of modifying parameters at a second training stage that incorporates the first loss function, the second loss function, and the third loss function.

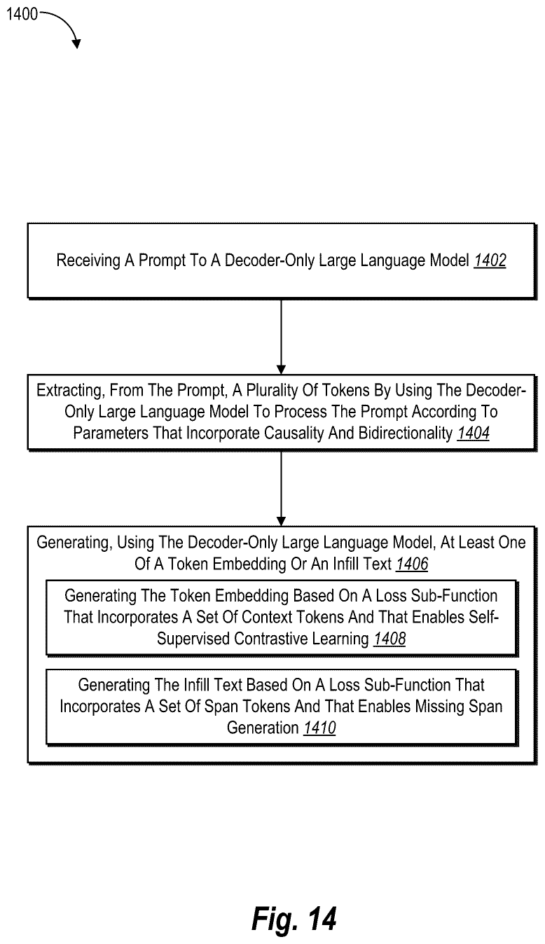

FIG. 14 illustrates an example series of acts 1400 for generating a token embedding or an infill text using a decoder-only large language model. In one or more implementations, the series of acts 1400 includes an act 1402 of receiving a prompt to a decoder-only large language model; an act 1404 of extracting, from the prompt, a plurality of tokens by using the decoder-only large language model to process the prompt according to parameters that incorporate causality and bidirectionality; an act 1406 of generating, using the decoder-only large language model, at least one of a token embedding or an infill text; an act 1408 of generating the token embedding based on a loss sub-function that incorporates a set of context tokens and that enables self-supervised contrastive learning; and an act 1410 of generating the infill text based on a loss sub-function that incorporates a set of span tokens and that enables missing span generation.

In one or more embodiments, the act 1402 also includes receiving a prompt to a decoder-only large language model, the prompt including at least one of an encoding request or a text infilling request. Additionally, in some embodiments, the act 1404 further includes an act of extracting, from the prompt, a plurality of tokens by using the decoder-only large language model to process the prompt according to parameters modified based on a loss function that incorporates causality and bidirectionality. In some implementations, the act 1406 also includes an act of generating, using the decoder-only large language model with the parameters modified based on the loss function, at least one of a token embedding from the plurality of tokens based on the encoding request or an infill text based on the text infilling request.

In one or more implementations, the series of acts 1400 includes processing the plurality of tokens using the decoder-only large language model according to parameters modified based on the loss function incorporating causality and bidirectionality captured by a causal-bidirectional hybrid attention mask. In some embodiments, the series of acts 1400 includes processing the plurality of tokens using the decoder-only large language model according to parameters modified based on the loss function incorporating causality via span tokens captured by the causal-bidirectional hybrid attention mask and bidirectionality via context tokens captured by the causal-bidirectional hybrid attention mask.

In some implementations, generating the token embedding includes using the decoder-only large language model with parameters modified based on a loss sub-function of the loss function that incorporates a set of context tokens and that enables self-supervised contrastive learning. In one or more embodiments, generating the infill text includes using the decoder-only large language model with parameters modified based on a loss sub-function of the loss function that incorporates a set of span tokens and that enables missing span generation. In one or more implementations, the series of acts 1400 includes generating, using the decoder-only large language model and in response to a text generation request, predicted text based on the loss function including three loss sub-functions that enable causal attention and bidirectional attention.

Embodiments of the present disclosure may comprise or utilize a special purpose or general-purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory, etc.), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media. Non-transitory computer-readable storage media (devices) includes optical and/or non-optical memory, disks, or caches that store computer data interpretable by one or more processors to execute particular functions as described herein. A “network” is defined as one or more data links that enable the transport of electronic data between computer systems and/or modules and/or other electronic devices. Information is transferred or provided over a network (either hardwired, wireless, or a combination of hardwired or wireless) to a computer to carry program code in the form of computer-executable instructions or data structures and which can be accessed by a general purpose or special purpose computer.

Computer-executable instructions comprise, for example, instructions and data which, when executed at a processor, cause a general-purpose computer, special purpose computer, or special purpose processing device to perform a certain function or group of functions. In some embodiments, computer-executable instructions are executed on a general-purpose computer to turn the general-purpose computer into a special purpose computer implementing elements of the disclosure. The computer executable instructions may be, for example, binaries, intermediate format instructions such as assembly language, or even source code.

Embodiments of the present disclosure can also be implemented in cloud computing environments. In this description, “cloud computing” is defined as a model for enabling on-demand network access to a shared pool of configurable computing resources. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth.

FIG. 15 illustrates, in block diagram form, an example computing device 1500 (e.g., the computing device 1100, the client device(s) 110, and/or the server device(s) 102) that may be configured to perform one or more of the processes described above. As shown by FIG. 15, the computing device can comprise a processor(s) 1502, memory 1504, a storage device 1506, an I/O interface 1508, and a communication interface 1510.

In particular embodiments, processor(s) 1502 includes hardware for executing instructions, such as those making up a computer program. As an example, and not by way of limitation, to execute instructions, processor(s) 1502 may retrieve (or fetch) the instructions from an internal register, an internal cache, memory 1504, or a storage device 1506 and decode and execute them. The computing device 1500 includes memory 1504, which is coupled to the processor(s) 1502. The memory 1504 may be used for storing data, metadata, and programs for execution by the processor(s). The memory 1504 may include one or more of volatile and non-volatile memories. The memory 1504 may be internal or distributed memory. The computing device 1500 includes a storage device 1506 includes storage for storing data or instructions. As an example, and not by way of limitation, storage device 1506 can comprise a non-transitory storage medium described above. The computing device 1500 also includes one or more input or output (“I/O”) devices/interfaces 1508, which are provided to allow a user to provide input to (such as user strokes), receive output from, and otherwise transfer data to and from the computing device 1500. These I/O devices/interfaces 1508 may include a mouse, keypad or a keyboard, a touch screen, camera, optical scanner, network interface, modem, other known I/O devices or a combination of such I/O devices/interfaces 1508.

The computing device 1500 can further include a communication interface 1510. The communication interface 1510 can include hardware, software, or both. The communication interface 1510 can provide one or more interfaces for communication (such as, for example, packet-based communication) between the computing device and one or more other computing devices (e.g., computing device 1500) or one or more networks. The computing device 1500 can further include a bus 1512. The bus 1512 can comprise hardware, software, or both that couples components of computing device 1500 to each other.

What is claimed is:

1. A computer-implemented method comprising:
generating from a plurality of tokens interpretable by a large language model:
a set of context tokens comprising tokens with bidirectional attention; and
a set of span tokens comprising tokens with causal attention and bidirectional attention;
modifying parameters of the large language model at a first training stage by utilizing a first loss function that incorporates the set of context tokens and a second loss function that incorporates the set of span tokens; and
modifying the parameters of the large language model at a second training stage by utilizing the first loss function, the second loss function, and a third loss function that incorporates the set of context tokens.

2. The computer-implemented method of claim 1, wherein generating the set of span tokens comprises assigning, utilizing a causal-bidirectional hybrid attention mask, a contiguous span of tokens of the plurality of tokens interpretable by the large language model to have causal attention with one another.

3. The computer-implemented method of claim 1, wherein generating the set of span tokens comprises assigning, utilizing a causal-bidirectional hybrid attention mask, a contiguous span of tokens of the plurality of tokens interpretable by the large language model to have bidirectional attention with the set of context tokens.

4. The computer-implemented method of claim 1, wherein generating the set of context tokens comprises assigning, utilizing a causal-bidirectional hybrid attention mask, non-contiguous tokens of the plurality of tokens interpretable by the large language model to have bidirectional attention with one another.

5. The computer-implemented method of claim 1, wherein the second loss function enables the large language model to perform missing span generation by modifying the parameters of the large language model using the set of span tokens, the large language model comprising a decoder-only large language model.

6. The computer-implemented method of claim 5, wherein the first loss function enables the large language model to perform masked next token prediction by modifying the parameters of the large language model using the set of context tokens.

7. The computer-implemented method of claim 1, wherein the third loss function enables the large language model to perform self-supervised contrastive learning by modifying the parameters of the large language model using the set of context tokens, the large language model comprising a decoder-only large language model.

8. A system comprising:
one or more memory devices; and
one or more processors configured to cause the system to:
generate, from a plurality of tokens interpretable by a large language model, a set of context tokens capturing bidirectional attention and a set of span tokens capturing causal attention; and
modify parameters of the large language model according to:
a first loss function that incorporates the set of context tokens and that enables masked next token prediction by the large language model;
a second loss function that incorporates the set of span tokens and that enables missing span generation by the large language model; and
a third loss function that incorporates the set of context tokens and that enables self-supervised contrastive learning by the large language model.

9. The system of claim 8, wherein the one or more processors are further configured to cause the system to:
generate the set of span tokens capturing causal attention by assigning, utilizing a causal-bidirectional hybrid attention mask, a contiguous span of tokens of the plurality of tokens interpretable by the large language model to have causal attention with one another; and
generate the set of context tokens capturing bidirectional attention by assigning, utilizing the causal-bidirectional hybrid attention mask, additional tokens of the plurality of tokens flanking the set of span tokens and attending to one another.

10. The system of claim 9, wherein the one or more processors are further configured to cause the system to generate the set of span tokens capturing bidirectional attention by assigning, utilizing the causal-bidirectional hybrid attention mask, one or more tokens of the set of span tokens to have bidirectional attention to the set of context tokens.

11. The system of claim 8, wherein modifying the parameters of the large language model according to the first loss function comprises modifying the parameters of the large language model at a first training stage that involves modifying the parameters of the large language model over a number of iterations before a second training stage.

12. The system of claim 8, wherein modifying the parameters of the large language model according to the third loss function comprises modifying the parameters of the large language model at a first training stage that involves modifying the parameters of the large language model over a number of iterations before a second training stage.

13. The system of claim 8, wherein modifying the parameters of the large language model according to the second loss function comprises modifying the parameters of the large language model at a second training stage that involves modifying the parameters of the large language model over a number of iterations after a first training stage.

14. The system of claim 13, wherein modifying the parameters of the large language model comprises:
modifying parameters at a first training stage that incorporates the first loss function and the second loss function and omits the third loss function; and
modifying parameters at a second training stage that incorporates the first loss function, the second loss function, and the third loss function.

15. A non-transitory computer readable medium storing executable instructions which, when executed by a processing device, cause the processing device to perform operations comprising:
receiving a prompt to a decoder-only large language model, the prompt comprising at least one of an encoding request or a text infilling request;
extracting, from the prompt, a plurality of tokens by using the decoder-only large language model to process the prompt according to parameters modified based on a loss function that incorporates causality and bidirectionality; and
generating, using the decoder-only large language model with the parameters modified based on the loss function, at least one of a token embedding from the plurality of tokens based on the encoding request or an infill text based on the text infilling request.

16. The non-transitory computer readable medium of claim 15, wherein the operations further comprise processing the plurality of tokens using the decoder-only large language model according to parameters modified based on the loss function incorporating causality and bidirectionality captured by a causal-bidirectional hybrid attention mask.

17. The non-transitory computer readable medium of claim 16, wherein the operations further comprise processing the plurality of tokens using the decoder-only large language model according to parameters modified based on the loss function incorporating causality via span tokens captured by the causal-bidirectional hybrid attention mask and bidirectionality via context tokens captured by the causal-bidirectional hybrid attention mask.

18. The non-transitory computer readable medium of claim 15, wherein generating the token embedding comprises using the decoder-only large language model with parameters modified based on a loss sub-function of the loss function that incorporates a set of context tokens and that enables self-supervised contrastive learning.

19. The non-transitory computer readable medium of claim 15, wherein generating the infill text comprises using the decoder-only large language model with parameters modified based on a loss sub-function of the loss function that incorporates a set of span tokens and that enables missing span generation.

20. The non-transitory computer readable medium of claim 15, wherein the operations further comprise generating, using the decoder-only large language model and in response to a text generation request, predicted text based on the loss function comprising three loss sub-functions that enable causal attention and bidirectional attention.
